(19) United States
(12) Patent Application Publication
(10) Pub. No.: US 2026/0002790 A1
(43) Pub. Date: Jan. 1, 2026

(54) NAVIGATION METHOD AND APPARATUS, DEVICE, MEDIUM AND PROGRAM PRODUCT

(71) Applicant: TENCENT TECHNOLOGY (SHENZHEN) COMPANY LIMITED, Shenzhen (CN)

(72) Inventor: Jingbo FAN, Shenzhen (CN)

(21) Appl. No.: 19/317,127

(22) Filed: Sep. 2, 2025

Related U.S. Application Data
(63) Continuation of application No. PCT/CN2024/102233, filed on Jun. 28, 2024.

(30) Foreign Application Priority Data
Jul. 26, 2023 (CN) 202310932079.0

(51) Int. Cl. G01C 21/36

(52) U.S. Cl. CPC G01C 21/3632; G01C 21/367

(57) ABSTRACT

This application relates to the field of navigation technologies, and provides a navigation method and a related apparatus, to improve continuous navigation efficiency. The method includes presenting a real-time position of a target object moving along a navigation route in a navigation interface for the target object, the navigation route comprising at least one consecutive turning point group, and each consecutive turning point group comprising at least two turning points that conform to a preset point spacing condition; and presenting turn indication information for the at least two turning points in the i^{th} consecutive turning point group in the navigation interface when a distance between the target object and an i^{th} consecutive turning point group conforms to a preset distance range, the i^{th} consecutive turning point group being one of the at least one consecutive turning point group.

### RELATED APPLICATIONS

This application is a continuation of PCT Application No. PCT/CN2024/102233, filed on Jun. 28, 2024, which claims priority to Chinese Patent Application No. 2023109320790, filed with the China National Intellectual Property Administration on Jul. 26, 2023, and entitled “NAVIGATION METHOD AND RELATED APPARATUS”, which are both incorporated herein by reference in their entirety.

### FIELD OF THE TECHNOLOGY

This application relates to the field of navigation technologies.

### BACKGROUND OF THE DISCLOSURE

With the rapid development of computer technology and communication technology, navigation has become widely used. Generally, navigation mainly refers to planning a navigation route based on a specified starting point and end point.

In the related art, in a navigation process, when a target object moves to an intersection, a movement direction of the target object may be prompted. However, in a scenario involving consecutive turns, due to the close proximity of intersections, after a previous turn indication is presented, a subsequent turn indication may trigger the timing for canceling the prompt before it is displayed. As a result, the target object fails to obtain accurate navigation information in time, consequently being prone to taking a wrong turn during subsequently, further causing deviation and affecting a navigation effectiveness.

### SUMMARY

Embodiments of this application provide a navigation method and apparatus, a device, a medium, and a program product, to improve a navigation effect in a scenario involving consecutive turns.

According to a first aspect, an embodiment of this application provides a navigation method, including: presenting a real-time position of a target object moving along a navigation route in a navigation interface for the target object, the navigation route comprising at least one consecutive turning point group, and each consecutive turning point group comprising at least two turning points that conform to a preset point spacing condition; and presenting turn indication information for the at least two turning points in the i^{th} consecutive turning point group in the navigation interface when a distance between the target object and an i^{th} consecutive turning point group conforms to a preset distance range, the i^{th} consecutive turning point group being one of the at least one consecutive turning point group.

According to another aspect, an embodiment of this application provides an electronic device, including a processor and a memory, the memory having a computer program stored therein, and the computer program, when executed by the processor, causing the processor to perform the operations of the foregoing method.

According to another aspect, an embodiment of this application provides a non-transitory computer-readable storage medium, including a computer program, the computer program, when run on an electronic device, causing the electronic device to perform the operations of the foregoing method.

In embodiments consistent with the present disclosure, an electronic device presents a real-time position of the target object moving along a navigation route in an navigation interface for a target object; and for each consecutive turning point group, presents, when a distance between the target object and an i^{th} consecutive turning point group conforms to a preset distance range, turn indication information for turning points included in the i^{th} consecutive turning point group in the navigation interface.

Accordingly, in a navigation process, when the target object needs to make consecutive turns based on an indication of the i^{th} consecutive turning point group, the turn indication information for the turning points in the i^{th} consecutive turning point group is presented. Such a manner of simultaneously presenting turn indication information for at least two turning points based on one consecutive turning point group as a unit can effectively increase an indication duration for each turning point, and prevent the target object from entering a wrong intersection, thereby improving a navigation effect, further reducing user operation errors caused by incorrect turns during moments of panic, and improving driving stability and safety.

Other features and advantages of this application are described in the following specification, and partially become apparent from the specification, or may be learned through implementations of this application. Objectives and other advantages of this application may be implemented and obtained by using structures particularly pointed out in the written specification, claims, and accompanying drawings.

### BRIEF DESCRIPTION OF THE DRAWINGS

FIG. 1 is a schematic diagram of an application scenario according to an embodiment of this application.

FIG. 2 is a schematic flowchart of a navigation method according to an embodiment of this application.

FIG. 3 is a schematic diagram of a navigation interface according to an embodiment of this application.

FIG. 4 is a schematic diagram of three turning points according to an embodiment of this application.

FIG. 5A is a schematic logic diagram of determining a consecutive turning point group according to an embodiment of this application.

FIG. 5B is another schematic logic diagram of determining a consecutive turning point group according to an embodiment of this application.

FIG. 6A is a schematic diagram of a navigation interface when entering a turning point 1 according to an embodiment of this application.

FIG. 6B is a schematic diagram of a navigation interface when passing through a turning point 1 according to an embodiment of this application.

FIG. 6C is a schematic diagram of a navigation interface when passing through a turning point 2 according to an embodiment of this application.

FIG. 7 is a schematic diagram of dragging in a turn guidance area according to an embodiment of this application.

FIG. 8A is a schematic diagram of a guidance sub-animation for a turning point A according to an embodiment of this application.

FIG. 8B is a schematic diagram of a guidance sub-animation for a turning point B according to an embodiment of this application.

FIG. 8C is a schematic diagram of a guidance sub-animation for a turning point C according to an embodiment of this application.

FIG. 9A is another schematic diagram of a guidance sub-animation for a turning point A according to an embodiment of this application.

FIG. 9B is another schematic diagram of a guidance sub-animation for a turning point B according to an embodiment of this application.

FIG. 9C is another schematic diagram of a guidance sub-animation for a turning point C according to an embodiment of this application.

FIG. 10 is a schematic diagram of a static guidance image for a turning point A according to an embodiment of this application.

FIG. 11 is a schematic diagram of a turn guidance area according to an embodiment of this application.

FIG. 12 is another schematic diagram of a turn guidance area according to an embodiment of this application.

FIG. 13 is a schematic diagram of a turn guidance area when a target object passes through the last turning point according to an embodiment of this application.

FIG. 14 is a schematic diagram of a pass-through baseline according to an embodiment of this application.

FIG. 15 is a schematic logic diagram of determining a pass-through baseline according to an embodiment of this application.

FIG. 16 is a schematic diagram of an intersection baseline according to an embodiment of this application.

FIG. 17 is a schematic diagram of a virtual camera perspective according to an embodiment of this application.

FIG. 18 is a schematic interaction diagram according to an embodiment of this application.

FIG. 19 is a schematic structural diagram of a navigation apparatus according to an embodiment of this application.

FIG. 20 is a schematic structural diagram of an electronic device according to an embodiment of this application.

### DESCRIPTION OF EMBODIMENTS

To make objectives, technical solutions, and advantages of embodiments of this application clearer, the following clearly and completely describes the technical solutions of this application with reference to the accompanying drawings in some embodiments consistent with the present disclosure. It is clear that the described embodiments are some rather than all of the embodiments of the technical solutions of this application. All other embodiments obtained by persons of ordinary skill in the art based on the embodiments recorded in the document of this application without creative efforts shall fall within the protection scope of the technical solutions of this application.

In some embodiments consistent with the present disclosure, in practical application, collection and processing of related navigation data need to strictly comply with the requirements of related national laws and regulations, informed consent or separate consent from personal information subjects needs to be obtained, and subsequent data use and processing activities need to be carried out within the scope of laws, regulations, and the authorization of the personal information subjects.

The following describes some concepts involved in some embodiments consistent with the present disclosure.

SD Map: A full name is a standard definition map.

HD Map: A full name is a high definition map.

Turning point: It may also be referred to as a maneuver point, and is a position on a digital map where a driver is guided to perform maneuvers such as turning, decelerating, changing lanes, or exiting. Generally, it is a position such as an intersection turning position, an intersection diverging position, or an intersection merging position. In some embodiments consistent with the present disclosure, the turning point included in one consecutive turning point group is specifically the intersection turning position.

This application relates to vehicle navigation technology in an intelligent transportation system. An intelligent traffic system (ITS), which may also be referred to as an intelligent transportation system, is a comprehensive transportation system that effectively and comprehensively applies advanced science and technologies (for example, information technology, computer technology, data communication technology, sensor technology, electronic control technology, automatic control theory, operations research, and artificial intelligence) to transportation, service control, and vehicle manufacturing, and enhances the connection between vehicles, roads, and users, thereby ensuring safety, improving efficiency, protecting the environment, and conserving energy.

The vehicle navigation technology is a technology that maps a real-time positional relationship between vehicle and a road to a visual navigation interface based on positioning data provided by a satellite positioning system, to provide a navigation function to a vehicle-associated object (for example, a vehicle driving object or a vehicle riding object) in a driving process of the vehicle from a starting point to an end point. In addition, through the visual navigation interface, the vehicle-associated object may learn a driving status of the vehicle, and may further learn information such as a current position of the vehicle, a driving route of the vehicle, a speed of the vehicle, and road conditions ahead.

The following briefly introduces design ideas of some embodiments consistent with the present disclosure.

With the rapid development of computer technology and communication technology, navigation has been widely used in people's daily travel. Generally, navigation mainly refers to planning a navigation route based on a specified starting point and end point.

In the related art, in a navigation process, when a target object moves to an intersection, a movement direction of the target object may be prompted. However, in a scenario involving consecutive turns, due to the close proximity of intersections, after a previous turn indication is presented, a subsequent turn indication may trigger the timing for canceling the prompt before it is displayed. As a result, the target object fails to obtain accurate navigation information in time, consequently being prone to taking a wrong turn during subsequent turning, further causing deviation and affecting a navigation effect.

In some embodiments consistent with the present disclosure, in response to a trigger operation performed by the target object in the navigation interface, a terminal device presents, in the navigation interface, a real-time position of the target object moving along a navigation route, and for each consecutive turning point group, presents, in the navigation interface when a distance between the target object and a consecutive turning point group conforms to a preset distance range, turn indication information for turning points included in the consecutive turning point group.

Accordingly, in a navigation process, when the target object needs to make consecutive turns, the turn indication information for the turning points in the consecutive turning point group is presented, to prevent the target object from entering a wrong intersection, thereby improving a navigation effect, further reducing operation errors caused by incorrect turns during moments of panic, and improving driving stability and safety.

The following describes embodiments of this application with reference to the accompanying drawings of the specification. The embodiments described herein are merely intended to describe and explain this application, but are not intended to limit this application. In addition, some embodiments consistent with the present disclosure and features in the embodiments may be mutually combined without conflict.

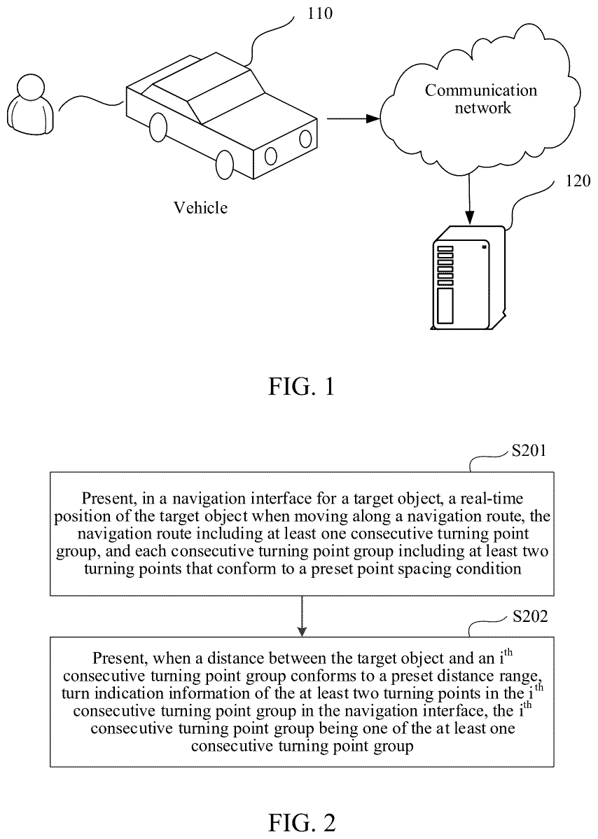

FIG. 1 is a schematic diagram of an application scenario according to an embodiment of this application. The application scenario diagram includes a terminal device 110 and a server 120.

In some embodiments consistent with the present disclosure, the terminal device 110 includes, but is not limited to, devices such as a mobile phone, a tablet computer, a notebook computer, a desktop computer, an ebook reader, an intelligent voice interaction device, an intelligent home appliance, an in-vehicle terminal, and an aircraft. For example, the terminal device in FIG. 1 is an in-vehicle terminal, the terminal device may be installed with a navigation-related client, which may be software (such as a browser or map software), or may be a web page, a mini program, or the like.

The server 120 is a backend server corresponding to software, a web page, a mini program, or the like, or a server related to displaying the driving status of a vehicle. This is not specifically limited in this application. The server 120 may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

A navigation method in some embodiments consistent with the present disclosure may be performed by an electronic device. The electronic device may be the terminal device 110 or the server 120. To be specific, the method may be performed by the terminal device 110 or the server 120 separately, or may be performed by the terminal device 110 and the server 120 together.

In some embodiments, the terminal device 110 may communicate with the server 120 through a communications network. The communication network is a wired network or a wireless network.

FIG. 1 is an example for description. Actually, a quantity of terminal devices and a quantity of servers are not limited, and are not specifically limited in some embodiments consistent with the present disclosure.

In some embodiments consistent with the present disclosure, when there are a plurality of servers, the plurality of servers may form a blockchain, and the servers are nodes on the blockchain. According to the navigation method disclosed in some embodiments consistent with the present disclosure, involved navigation-related data, for example, a navigation route, a turning point, and turn guidance information may be stored in the blockchain.

In addition, some embodiments consistent with the present disclosure may be applied to various navigation scenarios, which include, but are not limited to, scenarios such as cloud technology, artificial intelligence, intelligent transportation, autonomous driving, assistance driving, and the like.

A method for displaying the driving status of a vehicle according to an embodiment of this application is described below with reference to the foregoing described application scenarios and with reference to the accompanying drawings. The foregoing application scenarios are merely shown for ease of understanding the spirit and principle of this application, and the implementations of this application are not limited in this aspect.

FIG. 2 is a schematic flowchart of a navigation method according to an embodiment of this application. For example, using a terminal device as an execution body, a specific implementation process of the method is as follows.

S201: The terminal device presents, in a navigation interface for a target object, a real-time position of the target object when moving along a navigation route, the navigation route including at least one consecutive turning point group, and each consecutive turning point group including at least two turning points that conform to a preset point spacing condition.

In one embodiment, the navigation interface is a display interface of a digital navigation map. The digital navigation map includes, but is not limited to, an SD map. The digital navigation map is installed in the terminal device in the form of software. The target object is an object that requires navigation, for example, may be a vehicle in vehicle navigation, or may be a person travelling by walking or cycling. In the vehicle navigation, the digital navigation map may be installed in a vehicle terminal of the vehicle, or may be installed in another terminal device located in the vehicle.

The terminal device may be installed with a navigation application (APP). The terminal device may obtain a starting point and an end point of the navigation route through the navigation APP. The navigation APP plans the navigation route from the starting point to the end point for the target object based on an entered starting point and end point. During navigation, the terminal device presents the navigation interface, and presents, in the navigation interface, the real-time position of the target object moving along the navigation route, to provide a continuous navigation service for the target object.

In addition to the road-related digital navigation map, the navigation interface may further include a virtual object corresponding to the target object, and the virtual object moves on the navigation map with the target object. An appearance of the virtual object may be set by the target object, or may be an appearance preset by the system. This is not limited. For example, in a vehicle navigation scenario, the appearance of the virtual object is a virtual vehicle.

In actual application, road conditions displayed in the navigation interface may be three-dimensional, and the navigation interface is a navigation interface of a three-dimensional digital navigation map. Certainly, road environments displayed in the navigation interface may also be two-dimensional, and the navigation interface is a navigation interface of a two-dimensional digital navigation map. The target object may perform selection or switching according to an actual requirement.

For example, FIG. 3 is a schematic diagram of a navigation interface according to an embodiment of this application. The navigation interface is configured for presenting a navigation route from an xx Street to xx Building. A virtual vehicle is presented in the navigation interface, and the virtual vehicle is configured for representing a real-time position of a target object moving along the navigation route. The navigation interface may further include information such as an estimated arrival time, a total distance of the navigation route, an estimated driving duration, and a destination.

In actual application, the navigation interface may have a plurality of navigation perspectives, including heading-up and north-up modes. The heading-up mode means that the top of the navigation map changes according to a driving direction of the target vehicle (target object). For example, when the target vehicle is heading west, the top of the navigation map is facing west, and when the target vehicle is heading east, the top of the navigation map is facing east. Accordingly, the driver can determine which direction to turn by simply referring to left or right on the navigation map, making it easier for the driver to control the driving direction of the vehicle. The north-up mode means that the orientation of the navigation map always keeps north at the top, remaining fixed and not changing with the driving of the target vehicle. The driver mainly relies on the direction or adjusts the navigation device to the north-up direction to determine which direction to turn. This mode is suitable for a user with a good sense of direction, and may allow the user to keep track of the driving direction of the vehicle at any time. One embodiment is mainly applicable to a navigation mode with a heading-up navigation perspective.

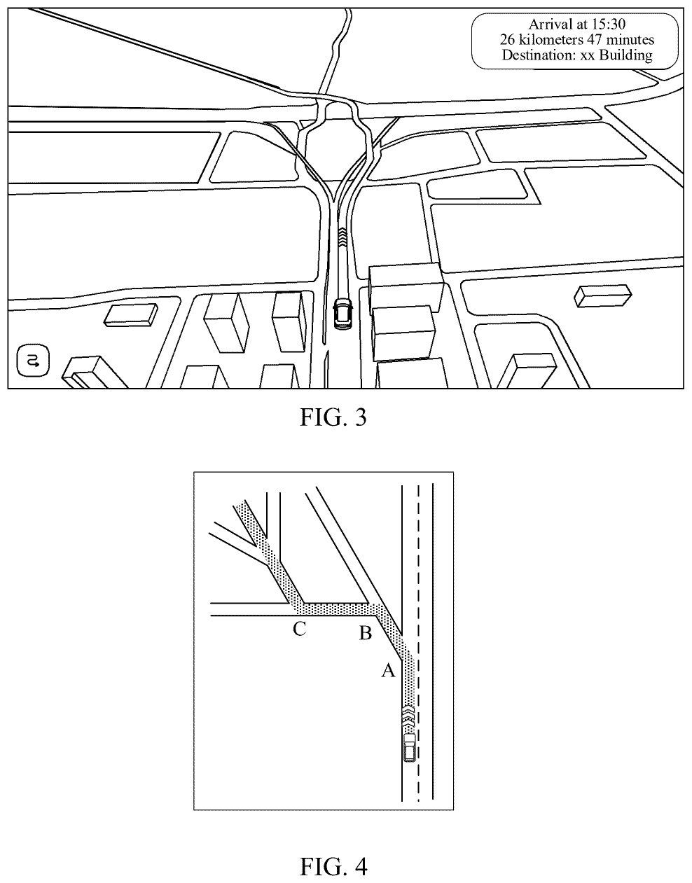

In one embodiment, the navigation route may include one or more consecutive turning point groups, each consecutive turning point group includes at least two turning points, and the at least two turning points conform to a preset point spacing condition. The quantity of turning points included in each consecutive turning point group may be the same or may vary. This is not limited. For example, referring to FIG. 4, a navigation route 1 includes one consecutive turning point group, and the consecutive turning point group includes three turning points: a turning point A, a turning point B, and a turning point C.

In some embodiments, the terminal device may obtain position data of all turning points in the navigation route with reference to the navigation route; then determine, based on the obtained position data of the turning points, whether the navigation route includes at least one consecutive turning point group; and determine turning points included in each of the at least one consecutive turning point group.

Specifically, in some embodiments, when one or more consecutive turning point groups in the navigation route are determined, at least one of the following embodiments may be used, but is not limited thereto:

First embodiment: If one group of turning points in the turning points in the navigation route that conforms to a preset adjacent point condition, the group of turning points is used as one consecutive turning point group, the preset adjacent point condition being that distances between two adjacent turning points in the group of turning points are all less than an adjacent point distance threshold (L1).

Specifically, starting from the second turning point in the turning points, the terminal device determines a distance between a current turning point and a previous turning point based on position data between the current turning point and the previous turning point. When the distance between two adjacent turning points in one group of turning points is less than the adjacent point distance threshold, the terminal device uses the group of turning points as the consecutive turning point group.

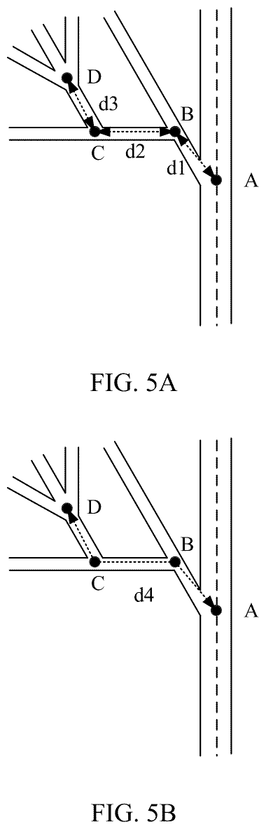

For example, FIG. 5A is a schematic diagram of a navigation route according to an embodiment of this application. The navigation route includes a turning point A, a turning point B, a turning point C, and a turning point D. A pass-through sequence of the turning point A, the turning point B, the turning point C, and the turning point D is: turning point A→turning point B→turning point C→turning point D. The terminal device determines a distance d1 between the turning point A and the turning point B, a distance d2 between the turning point B and the turning point C, and a distance d3 between the turning point C and the turning point D based on obtained position data respectively corresponding to the turning point A, the turning point B, the turning point C, and the turning point D. Assuming that L1 is 200 meters, d1 is less than 200 meters, d2 is less than 200 meters, and d3 is greater than 200 meters, the turning point A, the turning point B, and the turning point C belong to one group of turning points that conforms to the preset adjacent point condition. Therefore, the terminal device uses the turning point A, the turning point B, and the turning point C as one consecutive turning point group.

Second embodiment: If one group of turning points in the turning points in the navigation route that conforms to a preset overall condition, the group of turning points is used as one consecutive turning point group, the preset overall condition being that a sum of the distances between two adjacent turning points in the group of turning points is less than a specified overall distance threshold (L2).

The distance between adjacent turning points may be directly determined based on position data of the two turning points.

For example, FIG. 5B is a schematic diagram of a navigation route according to an embodiment of this application. The navigation route includes a turning point A, a turning point B, a turning point C, and a turning point D. A pass-through sequence of the turning point A, the turning point B, the turning point C, and the turning point D is: turning point A→turning point B→turning point C→turning point D. The terminal device may determine a distance d1 between the turning point A and the turning point B, a distance d2 between the turning point B and the turning point C, and a distance d3 between the turning point C and the turning point D based on obtained position data respectively corresponding to the turning point A, the turning point B, the turning point C, and the turning point D. Assuming that L2 is 500 meters, and d1+d2 is less than 500 meters, the turning point A, the turning point B, and the turning point C belong to one group of turning points that conforms to the preset overall condition. The terminal device uses the turning point A, the turning point B, and the turning point C as one consecutive turning point group.

In some other embodiments, the server may alternatively obtain the position data of all turning points in the navigation route with reference to the navigation route; determine, based on the obtained position data of the turning points, whether the navigation route includes at least one consecutive turning point group; determine the turning points included in each of the at least one consecutive turning point group; and then transmit determined one or more consecutive turning point groups to the terminal device. Certainly, another device having a data processing capability may alternatively identify each consecutive turning point group in the navigation route.

The consecutive turning point group may be quickly and accurately selected from the navigation route through a spacing between adjacent turning points or an overall spacing between a plurality of turning points, thereby improving efficiency and precision of determining the consecutive turning point group.

S202: Present, when a distance between the target object and an i^{th} consecutive turning point group conforms to a preset distance range, turn indication information of the at least two turning points in the i^{th} consecutive turning point group in the navigation interface.

The i^{th} consecutive turning point group is one of the at least one consecutive turning point group. When there is one consecutive turning point group in the navigation route, the value of i is 1. When there are a plurality of consecutive turning point groups in the navigation route, the value of i is determined based on a sequential order of the consecutive turning point groups in the navigation route. For example, if there are three consecutive turning point groups in the navigation route, in the driving direction indicated by the navigation route, the first consecutive turning point group at which the target object arrives is a first consecutive turning point group, the second consecutive turning point group at which the target object arrives is a second consecutive turning point group, and the third consecutive turning point group at which the target object arrives is a third consecutive turning point group.

The turn indication information is configured for indicating target driving directions respectively corresponding to the at least two turning points in one consecutive turning point group. The turn indication information may further be configured for indicating a distance between the target object and a corresponding turning point.

The turn indication information may be static prompt information (for example, text or static arrow guidance), may be dynamic prompt information (for example, dynamic arrow guidance), or the like. Different types of turn indication information may correspond to different information prompt durations. For example, an information prompt duration corresponding to the static prompt information may be 1s, and an information prompt duration corresponding to the dynamic prompt information may be 2s. The target object may configure the type of the turn indication information through a navigation application, and configure the prompt duration corresponding to the turn indication information.

According to the foregoing embodiments, in a navigation process, when the target object needs to make consecutive turns based on an indication of one consecutive turning point group of the navigation route, the turn indication information for the turning points in the consecutive turning point group is presented, to prevent the target object from entering a wrong intersection, thereby improving a navigation effect, further reducing user operation errors caused by incorrect turns during moments of panic, and improving driving stability and safety.

It is assumed that the navigation route includes M consecutive turning point groups, and each consecutive turning point group includes N turning points that conform to the preset point spacing condition. The M consecutive turning point groups are respectively represented as a consecutive turning point group 1zx, a consecutive turning point group 2zx, . . . , and a consecutive turning point group Mzx. In the i^{th} consecutive turning point group, the N turning points may be represented as a turning point izx-1, a turning point izx-2, . . . , and a turning point izx-N, and the i^{th} consecutive turning point group may be any one of the M consecutive turning point groups. The following only uses the i^{th} consecutive turning point group as an example for description.

When the distance between the target object and the i^{th} consecutive turning point group falls within the preset distance range, the terminal device may determine that the distance between the target object and the i^{th} consecutive turning point group conforms to the preset distance range.

In some embodiments, the terminal device determines that the distance between the target object and the i^{th} consecutive turning point group conforms to the preset distance range when any one of the following conditions is satisfied.

Condition 1: A distance between the target object and the first turning point of the N turning points is less than a second preset distance threshold (L3).

Specifically, the terminal device determines, based on a pass-through sequence when the distance between the target object and the first turning point of the N turning points is less than the second preset distance threshold, that the distance between the target object and the i^{th} consecutive turning point group conforms to the preset distance range.

The first turning point is determined based on a pass-through sequence of the N turning points in the navigation route.

L3 may be set based on an application scenario. For example, in an in-vehicle navigation scenario, a value of L3 may be set to 500 meters, and in a walking navigation scenario, a walking speed is slow compared with a vehicle driving speed, so that a value of L3 may be set to 100 meters.

Still referring to FIG. 4, it is assumed that the i^{th} consecutive turning point group includes the turning point A, the turning point B, and the turning point C. The terminal device determines, based on the navigation route, a pass-through sequence of the turning point A, the turning point B, and the turning point C as: turning point A→turning point B→turning point C. It is clear that the first turning point is the turning point A. Then, the terminal device determines, based on the pass-through sequence of the turning point A, the turning point B, and the turning point C when a distance between the target vehicle and the turning point A in the i^{th} consecutive turning point group is less than 500 meters, that the distance between the target vehicle and the i^{th} consecutive turning point group conforms to the preset distance range. In other words, when the target vehicle is heading to the turning point A and is 500 meters away from the turning point A, the terminal device determines that the distance between the target vehicle and the i^{th} consecutive turning point group conforms to the preset distance range.

Condition 2: The target object is expected to arrive at the first turning point of the N turning points within a specified duration.

Specifically, the terminal device estimates, based on a movement speed of the target object, a reference arrival time when the target object arrives at the first turning point of the N turning points; and determines, based on the reference arrival time when it is determined that the target object is expected to arrive at the first turning point of the N turning points within the specified duration, that the distance between the target object and the i^{th} consecutive turning point group conforms to the preset distance range.

The movement speed of the target object may be a current instantaneous speed, or may be an average speed. This is not limited. Time granularity of the specified duration includes, but is not limited to, minutes, seconds, or the like.

Still referring to FIG. 4, it is assumed that the i^{th} consecutive turning point group includes the turning point A, the turning point B, and the turning point C. The terminal device determines, based on the navigation route, that the pass-through sequence of the turning point A, the turning point B, and the turning point C is: turning point A→turning point B→turning point C. It is clear that the first turning point is the turning point A. The terminal device estimates a reference arrival time when the target vehicle arrives at the turning point A based on the movement speed of the target vehicle; and determines, based on the reference arrival time when the target vehicle is expected to arrive at the first turning point of the N turning points within 30 seconds, that the distance between the target vehicle and the i^{th} consecutive turning point group conforms to the preset distance range.

In the foregoing embodiments, whether to provide turn guidance on the i^{th} consecutive turning point group is determined in a time dimension. Accordingly, when entering a congested road section, the target vehicle triggers turn guidance just before approaching consecutive turning points, to avoid prematurely displaying the turn indication information. This helps maintain consistency between the turn indication information and the actual driving situation, thereby improving user experience.

In some embodiments, when the distance between the target object and the i^{th} consecutive turning point group conforms to the preset distance range, turn indication information for the N turning points in the i^{th} consecutive turning point group is presented in the navigation interface. The turn indication information is configured for indicating target driving directions respectively corresponding to the N turning points.

In some embodiments, the presenting, when the distance between the target object and the i^{th} consecutive turning point group conforms to the preset distance range, the turn indication information for the N turning points in the i^{th} consecutive turning point group in the navigation interface includes:
presenting, when a distance between the target object and the first turning point in the i^{th} consecutive turning point group is less than a first preset distance threshold, the turn indication information for the N turning points in the navigation interface; and
when the target object passes through a j^{th} turning point, presenting turn indication information for a (j+1)^{th} turning point, and turn indication information for a subsequent turning point after the (j+1)^{th} turning point in the navigation interface.

The first preset distance threshold may be the same as or different from the second preset distance threshold.

The subsequent turning point is a turning point located after the turning point of the N turning points in the i^{th} consecutive turning point group. For example, a subsequent turning point of the turning point A includes the turning point B and the turning point C, and a subsequent turning point of the turning point B is the turning point C.

If the current turning point is the last turning point in the i^{th} consecutive turning point group, and the last turning point have no subsequent turning point, in one embodiment, turn indication information for the last turning point may be presented in the navigation interface.

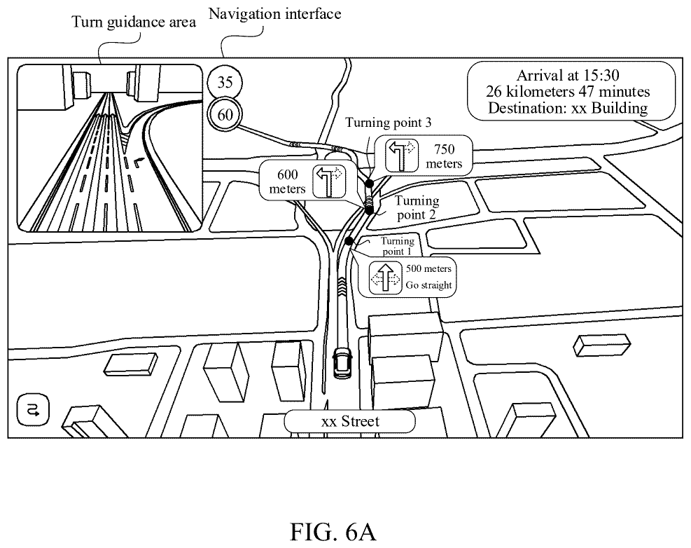

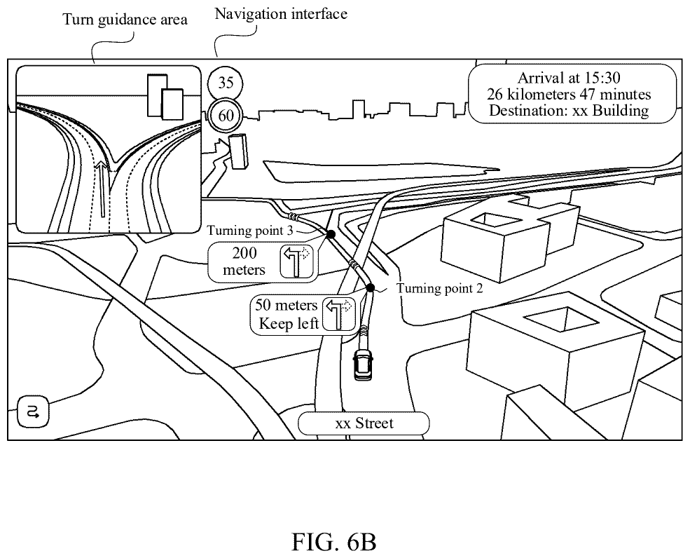

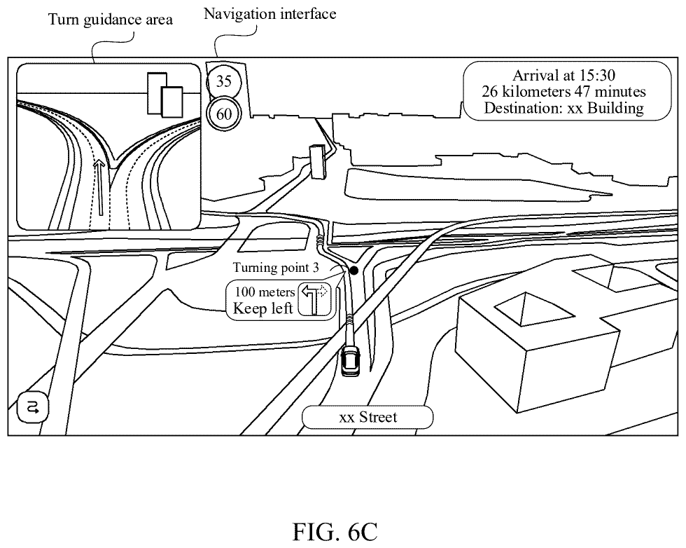

For example, it is assumed that the i^{th} consecutive turning point group includes a turning point 1, a turning point 2, and a turning point 3. Referring to FIG. 6A, when the target vehicle is driving, the terminal device presents turn indication information (Go straight for 500 meters) corresponding to the turning point 1, turn indication information (Keep left after 600 meters) corresponding to the turning point 2, and turn indication information (Keep left after 750 meters) corresponding to the turning point 3 in the navigation interface.

Referring to FIG. 6B, when the target object passes through the turning point 1, the terminal device presents turn indication information (Keep left after 50 meters) corresponding to the turning point 2 and turn indication information (Keep left after 200 meters) corresponding to the turning point 3 in the navigation interface.

Referring to FIG. 6C, when the target object passes through the turning point 2, the terminal device presents turn indication information (Keep left after 100 meters) corresponding to the turning point 3 in the navigation interface.

According to the foregoing embodiments, the terminal device may present, in the navigation process, turn indication information for unpassed turning points to the target object, to avoid user misinterpretation caused by turn indication information for passed turning points, thereby improving the efficiency of turn guidance.

In some embodiments, when the i^{th} consecutive turning point group includes N turning points, for a k^{th} turning point of the N turning points, 1≤k≤N, and the presenting, by the terminal device, turn indication information for the at least two turning points in the i^{th} consecutive turning point group in the navigation interface includes: presenting a prompt box corresponding to the k^{th} turning point, the prompt box including drivable directions corresponding to the k^{th} turning point, the drivable directions including a target driving direction of the target object at the k^{th} turning point, and the target driving direction being highlighted.

The highlighting may be implemented, but not limited to, manners such as brightening, bolding, and the like, but this is not limited thereto. The drivable directions corresponding to one turning point include drivable directions of the target object at an intersection at which the turning point is located. The drivable directions include, but are not limited to, straight, left turn, right turn, and the like.

The target driving direction at the k^{th} turning point is a direction on the navigation route that is among the drivable directions of the k^{th} turning point. For example, if the drivable directions of the k^{th} turning point include turning left and turning right, when the navigation route requires a right turn at the k^{th} turning point, this right turn is the target driving direction at the k^{th} turning point.

Still referring to FIG. 6A, turn indication information (Go straight for 500 meters) respectively corresponding to the turning point 1, the turning point 2, and the turning point 3 is presented in the form of prompt boxes. It is assumed that the prompt box corresponding to the turning point 1 (an example of the k^{th} turning point) includes a text “Go straight for 500 meters”, and further includes a plurality of arrows: left turn, straight, and right turn. Each arrow indicates one drivable direction corresponding to the turning point 1. The left turn arrow and the right turn arrow are indicated by using dashed lines, and the straight arrow is indicated by using a solid line (the solid line indicates the target driving direction), meaning that the target driving direction is going straight. The prompt box corresponding to the turning point 2 (an example of the k^{th} turning point) includes a text “Keep left after 600 meters”, and further includes a plurality of arrows: left turn and right turn. Each arrow indicates one drivable direction corresponding to the turning point 2. The right turn arrow is indicated by using a dashed line, and the left turn arrow is indicated by using a solid line, meaning that the target driving direction is turning left. The prompt box corresponding to the turning point 3 (an example of the k^{th} turning point) includes a text “Keep left after 750 meters”, and further includes a plurality of arrows: left turn and right turn. Each arrow indicates one drivable direction corresponding to the turning point 3. The right turn arrow is indicated by using a dashed line, and the left turn arrow is indicated by using a solid line, meaning that the target driving direction is turning left.

In the foregoing embodiments, by displaying the drivable directions, and highlighting the target driving direction, the user can easily learn the road conditions at the intersection and drive to the correct lane.

In some embodiments, to help the user quickly determine a correspondence between turning points and turn indication information, a prompt box corresponding to one turning point is presented in the navigation interface at a preset position associated with the k^{th} turning point.

The associated preset position may be within a surrounding area of the k^{th} turning point, for example, may be a preset position on a left side of the corresponding turning point, or may be a preset position on a right side of the corresponding turning point. This is not limited, as long as the associated preset position does not affect the presentation of the navigation route. Associated preset positions respectively corresponding to the N turning points may be the same or different.

Still referring to FIG. 6A, in the navigation interface, the prompt box corresponding to the turning point 1 is located on a right side of the turning point 1, the prompt box corresponding to the turning point 2 is located on a left side of the turning point 2, and the prompt box corresponding to the turning point 3 is located on a right side of the turning point 3.

By displaying the prompt box at the preset position associated with the k^{th} turning point, a display level relationship can be effectively established between the prompt box and the corresponding k^{th} turning point, thereby improving the specificity and clarity of the prompt box.

In some embodiments, a layer of the prompt box may be located above a layer of the navigation interface.

In some embodiments consistent with the present disclosure, the form (for example, a shape or a size) of the prompt box is not specifically limited. A style of the prompt box may be preset by the system or specified by the user.

In addition, referring to FIG. 6A, the terminal device may further present navigation information such as a destination of the navigation route, a distance to the destination, an estimated driving duration, and an estimated arrival time in an upper right area of the navigation interface.

In some embodiments, the navigation interface may further include a voice broadcast component. After the target object triggers (for example, taps) the voice broadcast component, the turn indication information for the N turning points is broadcast in a voice broadcast manner, to prompt the target object to turn.

In one embodiment, the voice broadcast component may be located in a turn guidance area below, or may be presented outside of the turn guidance area (for example, on a right side of the turn guidance area).

In one embodiment, in a movement process of the target object, the navigation interface may further include information such as a speed limit prompt of and a distance to the current turning point, but this is not limited thereto.

In some embodiments, the navigation interface further includes the turn guidance area. When the distance between the target object and the i^{th} consecutive turning point group conforms to the preset distance range, the terminal device may further present a guidance animation corresponding to the i^{th} consecutive turning point group in the turn guidance area. The guidance animation is configured for guiding the target object to pass through the i^{th} consecutive turning point group. The guidance animation may be a two-dimensional animation, or may be a three-dimensional animation. This is not limited. Dynamic images can help display the turning process more intuitively, to better guide the user to turn, thereby improving the navigation efficiency.

Specifically, in one embodiment, to make the turn guidance area and the navigation interface not interfere with each other, in one embodiment, a layer of the turn guidance area is located above the layer of the navigation interface. Through the layered design, targeted guidance for the i^{th} consecutive turning point group can be implemented without affecting the navigation process of the navigation interface. In addition, compared with directly adding the turn guidance area to the navigation interface, processing is simpler, and processing efficiency is higher. In one embodiment, the size and a position of the turn guidance area are not limited.

In one embodiment, a relative position relationship between the turn guidance area and the navigation interface may be fixed. For example, still referring to FIG. 6A, the turn guidance area is presented at a preset position on an upper left side of the navigation interface. Certainly, the turn guidance area may be located on the left side of the navigation interface, or may be located on an upper side, a lower side, or the right side of the navigation interface. The position of the turn guidance area is not limited, as long as the turn guidance area does not affect the presentation of the navigation route in the navigation interface.

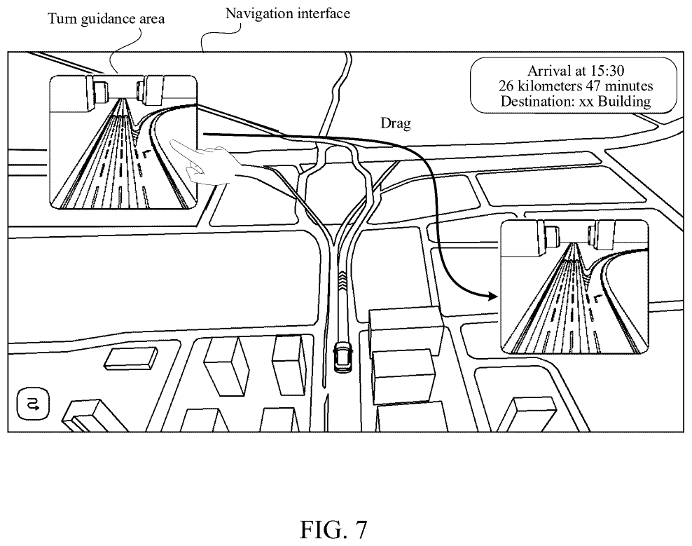

In another embodiment, a relative position relationship between the turn guidance area and the navigation interface may not be fixed. When the target object drags the turn guidance area, in response to a drag operation of the target object, the terminal device adjusts the turn guidance area to a position at which the turn guidance area is dragged by the target object. For example, FIG. 7 is a schematic diagram of a turn guidance area according to an embodiment of this application. The terminal device presents the turn guidance area in a left side area of the navigation interface; and in response to the drag operation of the target object, presents the dragged turn guidance area in a right side area of the navigation interface.

In one embodiment, for the guidance animation, segmented guidance or non-segmented guidance may be used. The segmented guidance and the non-segmented guidance are separately described below.

First guidance manner: segmented guidance. The guidance animation includes a dynamic turning process of the target object at the turning points. In the segmented guidance, the guidance animation may be divided into one or more guidance sub-animations based on the turning points, and by playing the corresponding guidance sub-animations, the target object is guided to pass through the corresponding turning points in the consecutive turning point group.

Specifically, in one embodiment, a guidance animation corresponding to the i^{th} consecutive turning point group includes: guidance sub-animations respectively corresponding to the N turning points. In a segmented guidance process, the terminal device may sequentially play guidance sub-animations corresponding to the turning points in the turn guidance area.

In one embodiment, considering that a plurality of drivable directions may exist at an intersection at which one turning point is located, to enable the user to focus on the target driving direction, in one embodiment, a guidance sub-animation corresponding to one turning point may specifically include: with an approach lane and an exit lane corresponding to one turning point as a visual center from a virtual camera perspective, a turning process of the target object passing through the approach lane and entering the exit lane. For details of a generation process of the guidance sub-animation, refer to the following descriptions. The guidance sub-animation may further include a process of driving from an exit lane of one turning point to an approach lane of a next turning point.

For example, before the target object turns at the turning point A, there are two lanes: a left-turn lane at the left side and a straight lane at the right side. After the target object turns at the turning point A, there is one lane: the straight lane. A guidance sub-animation corresponding to the turning point A includes: with the approach lane (left-turn lane) and the exit lane (straight lane) on which the turning point A is located as the visual center, a turning process of the target vehicle passing through the approach lane and entering the exit lane.

By presenting the respective corresponding guidance sub-animations based on the turning points, navigation guidance with the turning points as units can be more clearly provided in the consecutive turning point group, allowing the user to intuitively learn how to pass through each turning point.

In some embodiments, the playback timing of a guidance sub-animation corresponding to one turning point includes, but is not limited to, the following cases.

First playback timing: The terminal device may present, when the target object is approaching or entering an intersection at which one turning point is located, the guidance sub-animation corresponding to the turning point in the turn guidance area.

For the first turning point, the criterion for determining whether the target object is approaching or entering the intersection at which the first turning point is located may be any one of the following: the distance between the target object and the first turning point is less than a first preset distance threshold (L4), the target object is expected to arrive at the first turning point within a second specified duration, or the target object arrives at an intersection baseline corresponding to the first turning point, but this is not limited thereto. The second preset distance threshold may be the same as or different from the first preset distance threshold, and the second specified duration may be the same as or different from the first specified duration.

Starting from the second turning point, the criterion for determining whether the target object is approaching or entering an intersection at which one turning point is located may be: when the target object passes through the j^{th} turning point, a guidance sub-animation corresponding to the (j+1)^{th} turning point is played in the turn guidance area. The playback criteria include any one of the following: a distance between the target object and the j^{th} turning point is less than a third preset distance threshold (L5), the target object is expected to arrive at the j^{th} turning point within a third specified duration, and the target object arrives at an intersection baseline corresponding to the j^{th} turning point. The third preset distance threshold may be the same as or different from the second preset distance threshold, and the third specified duration may be the same as or different from the second specified duration. For details of a manner of determining whether the target object passes through the previous turning point, refer to the following descriptions.

In some embodiments, the presenting, by the terminal device when the distance between the target object and the i^{th} consecutive turning point group conforms to the preset distance range, the guidance animation corresponding to the i^{th} consecutive turning point group in the turn guidance area specifically includes the following operations:
playing, by the terminal device when the distance between the target object and the first turning point in the i^{th} consecutive turning point group is less than L3, the guidance sub-animation corresponding to the first turning point in the turn guidance area; and
performing the following operations separately starting from the second turning point in the i^{th} consecutive turning point group: playing, by the terminal device when the target object passes through the j^{th} turning point, the guidance sub-animation corresponding to the (j+1)^{th} turning point in the turn guidance area.

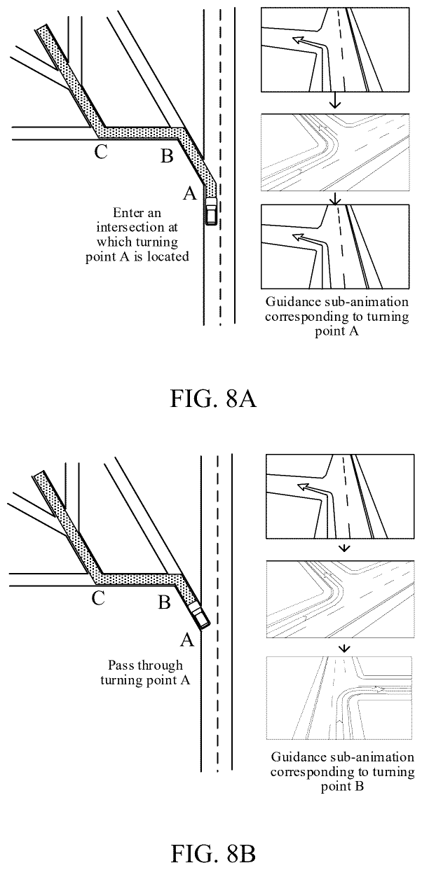

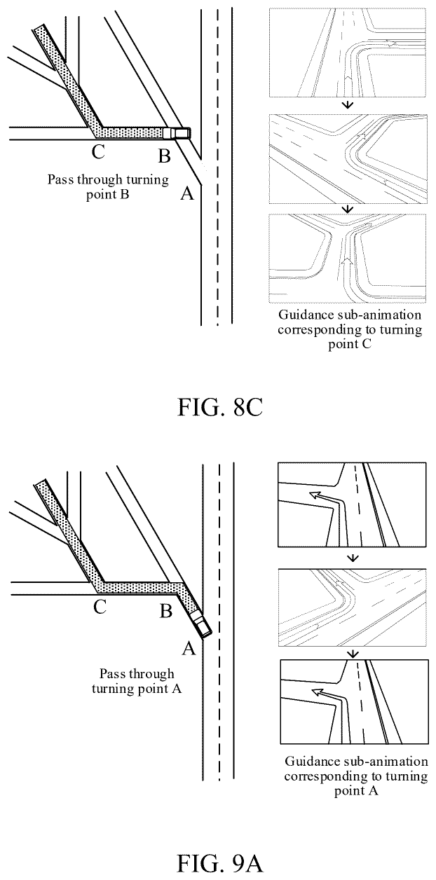

The turning point A, the turning point B, and the turning point C are still used as an example. Referring to FIG. 8A, when the target vehicle is entering the intersection at which the turning point A is located, the guidance sub-animation corresponding to the turning point A is displayed in the turn guidance area. The guidance sub-animation corresponding to the turning point A includes a movement process of the target vehicle turning left from the intersection at which the turning point A is located to the turning point B. Passable directions of the intersection at which the turning point A is located are: straight and left turn. In the guidance sub-animation corresponding to the turning point A, to make it easy for the user to view information, the target driving direction of the target object at the corresponding turning point may be highlighted. The highlighting may be implemented, but not limited to, manners such as brightening, bolding, and the like. This is not limited.

Referring to FIG. 8B, when the target object passes through the turning point A, a guidance sub-animation corresponding to the turning point B is played in the turn guidance area. The guidance sub-animation corresponding to the turning point B includes a movement process of the target object turning left to the turning point C from the intersection at which the turning point B is located. In the guidance sub-animation corresponding to the turning point B, the target object is prompted, by using a left-turn arrow, to turn left at the turning point B.

Referring to FIG. 8C, when the target object passes through the turning point B, a guidance sub-animation corresponding to the turning point C is played in the turn guidance area. The guidance sub-animation corresponding to the turning point C includes a movement process of the target object turning right from the intersection at which the turning point C is located to the next intersection. The left-turn arrow is presented in the guidance sub-animation corresponding to the turning point C, to prompt, by using the arrow, the target object to turn right at the turning point C.

Playing the guidance sub-animation for the (j+1)^{th} turning point only when passing through the j^{th} turning point can directly associate the playback of the guidance sub-animation with the current movement of the target object, to reduce the likelihood of the user being misled by guidance sub-animations for other turning points when needing to pass through a specific turning point, thereby improving navigation guidance precision.

Second playback timing: The terminal device may present, when the target object passes through an intersection at which one turning point is located, the guidance sub-animation corresponding to the turning point in the turn guidance area.

In some embodiments, the presenting, by the terminal device when the distance between the target object and the i^{th} consecutive turning point group conforms to the preset distance range, the turn indication information for the N turning points in the i^{th} consecutive turning point group in the turn guidance area of the navigation interface specifically includes the following operations:

performing the following operations separately for the N turning points in the i^{th} consecutive turning point group: playing, when the target object passes through a previous turning point, a guidance sub-animation corresponding to a current turning point in the turn guidance area.

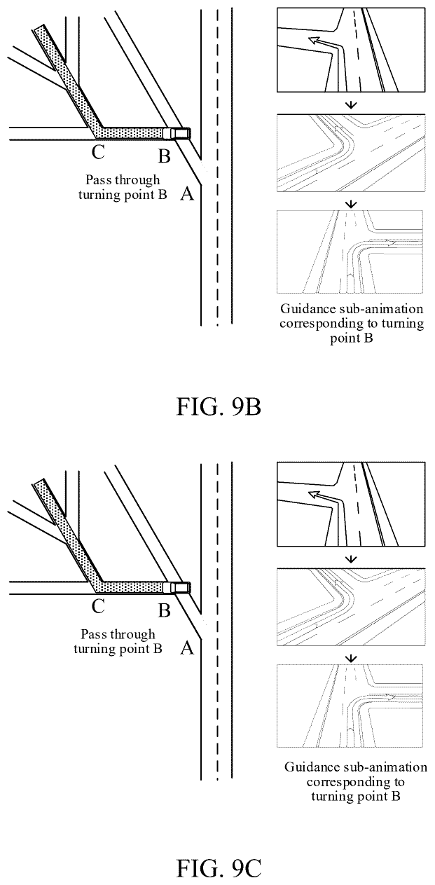

For example, referring to FIG. 9A, when the target object passes through the turning point A, the guidance sub-animation corresponding to the turning point A is displayed in the turn guidance area. The guidance sub-animation corresponding to the turning point A includes a movement process of the target vehicle turning left from the intersection at which the turning point A is located to the turning point B.

Referring to FIG. 9B, when the target object passes through the turning point B, the guidance sub-animation corresponding to the turning point B is played in the turn guidance area. The guidance sub-animation corresponding to the turning point B includes a movement process of the target object turning left to the turning point C from the intersection at which the turning point B is located. In the guidance sub-animation corresponding to the turning point B, the target object is prompted, by using the left-turn arrow, to turn left at the turning point B.

Referring to FIG. 9C, when the target object passes through the turning point C, the guidance sub-animation corresponding to the turning point C is played in the turn guidance area. The guidance sub-animation corresponding to the turning point C includes a movement process of the target object turning left from the intersection at which the turning point C is located to the next intersection. The left-turn arrow is presented in the guidance sub-animation corresponding to the turning point C, to prompt, by using the arrow, the target object to turn right at the turning point C.

In some embodiments, considering that the target object is heading to the first turning point before the guidance sub-animation for the first turning point is played, to improve turning accuracy of the target object at the first turning point, after presenting the turn guidance area in the navigation interface and before presenting the guidance sub-animation for the first turning point in the turn guidance area, the terminal device may further present a static guidance image for the first turning point in the turn guidance area.

Specifically, when the distance between the target object and the i^{th} consecutive turning point group conforms to the preset distance range (an example in which the distance between the target object and the first turning point is less than the second preset distance threshold is used), the terminal device presents the turn guidance area in the navigation interface, and presents the static guidance image corresponding to the first turning point in the turn guidance area.

To help the user focus on turning at the first turning point, in the static guidance image, the first turning point may be displayed at the center of the image. The static guidance image may include the drivable directions included in the first turning point and the highlighted target driving direction. For example, the first frame of image of the guidance sub-animation for the first turning point may be used as the static guidance image corresponding to the first turning point.

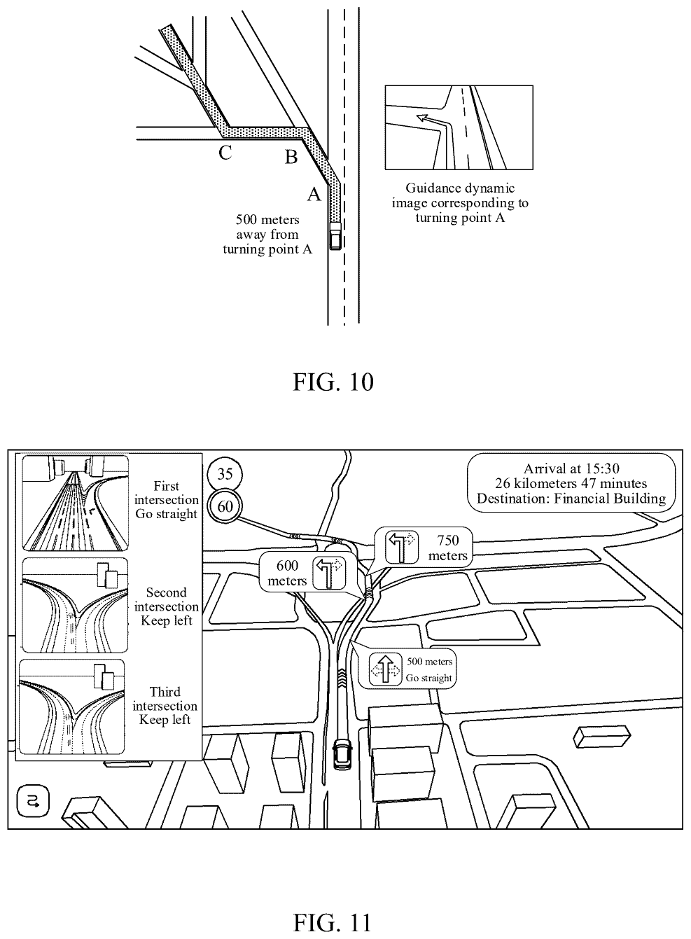

For example, referring to FIG. 10, when a distance between the target vehicle and the turning point A is 500 meters, the turn guidance area is presented in the navigation interface, and the static guidance image corresponding to the turning point A is presented in the turn guidance area. The static guidance image corresponding to the turning point A includes drivable directions at the intersection at which the turning point A is located: arrows corresponding to straight and left turn. The left-turn arrow is highlighted to prompt the target object to turn left at the turning point A. When the distance between the target vehicle and the turning point A is 300 meters, the guidance sub-animation corresponding to the turning point A is played in the turn guidance area.

In one embodiment, a guidance sub-animation corresponding to one turning point may be played once, or may be played a plurality of times. The quantity of playback times of the guidance sub-animation is not limited. The playback times of the guidance sub-animation may be preset by the system, or may be configured by the user.

In some embodiments, for the N turning points, the terminal device may further continuously display a static guidance image corresponding to the (j+1)^{th} turning point in the turn guidance area after playing of the guidance sub-animation corresponding to the j^{th} turning point is completed. In other words, after a guidance sub-animation corresponding to one turning point is played, in the turn guidance area, the target object is guided, by using a static image, to turn at the next turning point.

The static guidance image corresponding to the (j+1)^{th} turning point includes a target driving direction of the (j+1)^{th} turning point. The static guidance image may be one frame of image (for example, the last frame) in the guidance sub-animation for the (j+1)^{th} turning point, but this is not limited thereto. The static guidance image corresponding to the (j+1)^{th} turning point is similar to the static guidance image corresponding to the first turning point. Details are not described herein again.

For example, referring to FIG. 8A, three image frames included in the guidance sub-animation are respectively schematic turning diagrams before turning, during turning, and after turning. After playing the guidance sub-animation corresponding to the turning point A in the turn guidance area, the terminal device continuously displays the third image frame in FIG. 8A in the turn guidance area. The third image frame in FIG. 8A is centered on the turning point A to present the target driving direction at the turning point A as a left turn.

Referring to FIG. 8B, when the target vehicle passes through the turning point A, the terminal device plays the guidance sub-animation corresponding to the turning point B in the turn guidance area. Three image frames included in the guidance sub-animation are respectively schematic turning diagrams before turning, during turning, and after turning. After the guidance sub-animation corresponding to the turning point B is displayed, the third image frame in FIG. 8B is continuously displayed in the turn guidance area. The third image frame in FIG. 8B is centered on the turning point B to present the target driving direction at the turning point B as a left turn.

Referring to FIG. 8C, when the target vehicle passes through the turning point B, the terminal device plays the guidance sub-animation corresponding to the turning point C in the turn guidance area. Three image frames included in the guidance sub-animation are respectively schematic turning diagrams before turning, during turning, and after turning. After the guidance sub-animation corresponding to the turning point C is played, the third image frame in FIG. 8C is continuously displayed in the turn guidance area. The third image frame in FIG. 8C is centered on the turning point C to present the target driving direction at the turning point C as a right turn.

### Second Guidance Manner: Non-Segmented Guidance

In one embodiment, when the distance between the target object and the i^{th} consecutive turning point group conforms to the preset distance range, the terminal device may alternatively directly play the guidance animation corresponding to the i^{th} consecutive turning point group in the turn guidance area of the navigation interface.

In one embodiment, when the distance between the target object and the i^{th} consecutive turning point group conforms to the preset distance range, the terminal device starts to loop the guidance animation corresponding to the i^{th} consecutive turning point group in the turn guidance area until the terminal device passes through the last turning point of the i^{th} consecutive turning point group, at which point the playing of the guidance animation corresponding to the i^{th} consecutive turning point group is stopped in the turn guidance area. The quantity of playback times of the guidance animation may be one or more, which may be configured by the user through the APP.

For example, when the distance between the target object and the turning point A is 500 meters, the terminal device starts to loop the guidance animation corresponding to the i^{th} consecutive turning point group in the turn guidance area until the terminal device passes through the turning point C, at which point the playing of the guidance animation corresponding to the i^{th} consecutive turning point group is stopped in the turn guidance area.

When the user needs to make consecutive turns in a driving process, continuous turn guidance is completed through a dynamic large image. This allows the user to focus on each immediate action, thereby preventing the user from entering a wrong intersection, and greatly increasing driving certainty and the sense of safety.

Compared with the dynamic image, the static image requires less storage space, and consumes less data during transmission. Therefore, in situations where network conditions are poor or the terminal device has low performance, the static image can also be presented in the turn guidance area, to ensure a navigation effect.

Specifically, in one embodiment, when the distance between the target object and the i^{th} consecutive turning point group conforms to the preset distance range, the terminal device presents the turn guidance area in the navigation interface. In this case, the prompt information configured for prompting consecutive turns in front of the target object may be presented in the turn guidance area. When the target object is approaching or entering an intersection at which one turning point is located, a static guidance image corresponding to the turning point is presented in the turn guidance area. For the criteria for determining whether the target object is approaching or entering an intersection at which one turning point is located, refer to the criteria in the foregoing guidance animation. Details are not described herein again.

For example, the presenting, by the terminal device when the distance between the target object and the i^{th} consecutive turning point group conforms to the preset distance range, the turn indication information for the N turning points in the i^{th} consecutive turning point group in the turn guidance area of the navigation interface specifically includes the following operations:

displaying, by the terminal device when the distance between the target object and the first turning point in the i^{th} consecutive turning point group is less than L3, the static guidance image for the first turning point in the turn guidance area; and

performing the following operations separately starting from the second turning point in the i^{th} consecutive turning point group: presenting, when the target object passes through a previous turning point, the static guidance image corresponding to the current turning point in the turn guidance area.

An example in which the i^{th} consecutive turning point group includes the turning point 1, the turning point 2, and the turning point 3 is still used. When the target vehicle is entering the intersection at which the turning point 1 is located, the static guidance image corresponding to the turning point 1 is displayed in the turn guidance area. The static guidance image includes drivable directions at the intersection at which the turning point 1 is located: straight and left turn. The straight direction is highlighted to guide the target object to go straight at the turning point 1. In this case, the terminal device presents, in the navigation interface, turn guidance information corresponding to the turning point 1 (Go straight for 500 meters), turn guidance information corresponding to the turning point 2 (Keep left after 600 meters), and turn guidance information corresponding to the turning point 3 (Keep left after 750 meters).

When the target object passes through the turning point 1, the static guidance image corresponding to the turning point 2 is displayed in the turn guidance area. The static guidance image corresponding to the turning point 2 includes drivable directions at the intersection at which the turning point 2 is located: left turn and right turn. The left-turn direction is highlighted to guide the target object to turn left at the turning point 2. In this case, the terminal device presents, in the navigation interface, the turn guidance information corresponding to the turning point 2 (Keep left after 50 meters) and the turn guidance information corresponding to the turning point 3 (Keep left after 200 meters).

When the target object passes through the turning point 2, the static guidance image corresponding to the turning point 3 is displayed in the turn guidance area. The static guidance image corresponding to the turning point 3 includes drivable directions at the intersection at which the turning point 3 is located: left turn and right turn. The left-turn direction is highlighted to guide the target object to turn left at the turning point 3. In this case, the terminal device presents, in the navigation interface, navigation information (Keep left after 100 meters) corresponding to the turning point 3.

In another embodiment, when the distance between the target object and the i^{th} consecutive turning point group conforms to the preset distance range, the terminal device presents the turn guidance area in the navigation interface, and presents static guidance images respectively corresponding to the N turning points in the turn guidance area.

An example in which the i^{th} consecutive turning point group includes the turning point 1, the turning point 2, and the turning point 3 is used. Referring to FIG. 11, when the distance between the target vehicle and the i^{th} consecutive turning point group conforms to a preset distance range (for example, 500 meters away from the turning point 1), static guidance images respectively corresponding to the turning point 1, the turning point 2, and the turning point 3 are displayed in the turn guidance area. In the static guidance image corresponding to the turning point 1, the target object is guided, through the straight arrow, to go straight at an intersection (a first intersection) at which the first turning point is located. In the static guidance image corresponding to the turning point 2, the target object is guided, through the left-turn arrow, to turn left at an intersection (a second intersection) at which the second turning point is located. In the static guidance image corresponding to the turning point 3, the target object is guided, through the left-turn arrow, to turn left at an intersection (a third intersection) at which the third turning point is located.

The terminal device may further present a text in the turn guidance area. Specifically, in one embodiment, when the distance between the target object and the i^{th} consecutive turning point group conforms to the preset distance range, the terminal device presents the turn guidance area in the navigation interface. In this case, the prompt information configured for prompting consecutive turns in front of the target object may be presented in the turn guidance area. When the target object is approaching or entering an intersection at which one turning point is located, a guidance text corresponding to the turning point is presented in the turn guidance area. For the criteria for determining whether the target object is approaching or entering an intersection at which one turning point is located, refer to the criteria in the foregoing guidance animation. Details are not described herein again.

For example, the presenting, by the terminal device when the distance between the target object and the i^{th} consecutive turning point group conforms to the preset distance range, the turn indication information for the N turning points in the i^{th} consecutive turning point group in the turn guidance area of the navigation interface specifically includes the following operations:
displaying, by the terminal device when the distance between the target object and the first turning point in the i^{th} consecutive turning point group is less than L3, a guidance text for the first turning point in the turn guidance area; and
performing the following operations separately starting from the second turning point in the i^{th} consecutive turning point group: presenting, when the target object passes through a previous turning point, a text corresponding to the current turning point in the turn guidance area.

For example, when the target vehicle is entering the intersection at which the turning point 1 is located, a guidance text corresponding to the turning point 1 is displayed in the turn guidance area, and the guidance text for the turning point 1 is going straight for 200 meters. When the target object passes through the turning point 1, a guidance text corresponding to the turning point 2 is displayed in the turn guidance area, and the guidance text corresponding to the turning point 2 is keeping left after 50 meters. When the target object passes through the turning point 2, a guidance text corresponding to the turning point 3 is displayed in the turn guidance area, and the guidance text corresponding to the turning point 3 is keeping left after 200 meters.

In another embodiment, when the distance between the target object and the i^{th} consecutive turning point group conforms to the preset distance range, the terminal device presents the turn guidance area in the navigation interface, and presents guidance texts respectively corresponding to the N turning points in the turn guidance area.

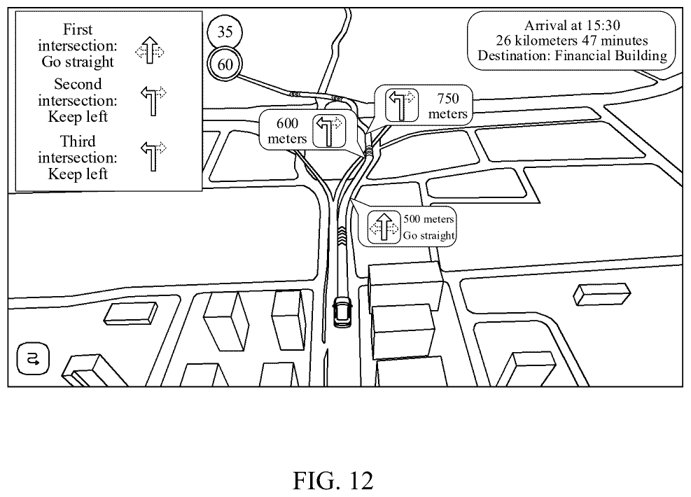

An example in which the i^{th} consecutive turning point group includes the turning point 1, the turning point 2, and the turning point 3 is used. Referring to FIG. 12, when the distance between the target vehicle and the i^{th} consecutive turning point group conforms to the preset distance range (for example, 500 meters away from the turning point 1), guidance texts respectively corresponding to the turning point 1, the turning point 2, and the turning point 3 are displayed in the turn guidance area. In some embodiments consistent with the present disclosure, to make it easy for the user to view the target driving direction, a driving arrow corresponding to the guidance text may be presented in the turn guidance area.

In some embodiments, considering that the turn guidance area occupies a specific space of the navigation interface, to reduce an impact of the turn guidance area on navigation, the terminal device may present the turn guidance area in the navigation interface when continuous turn guidance is required, and no longer presents the turn guidance area when continuous turn guidance is not required.

Specifically, in some embodiments consistent with the present disclosure, when the distance between the target object and the i^{th} consecutive turning point group conforms to the preset distance range, the terminal device presents the turn guidance area in the navigation interface. When the target object passes through the last turning point in the i^{th} consecutive turning point group, the terminal device no longer presents the turn guidance area in the navigation interface.

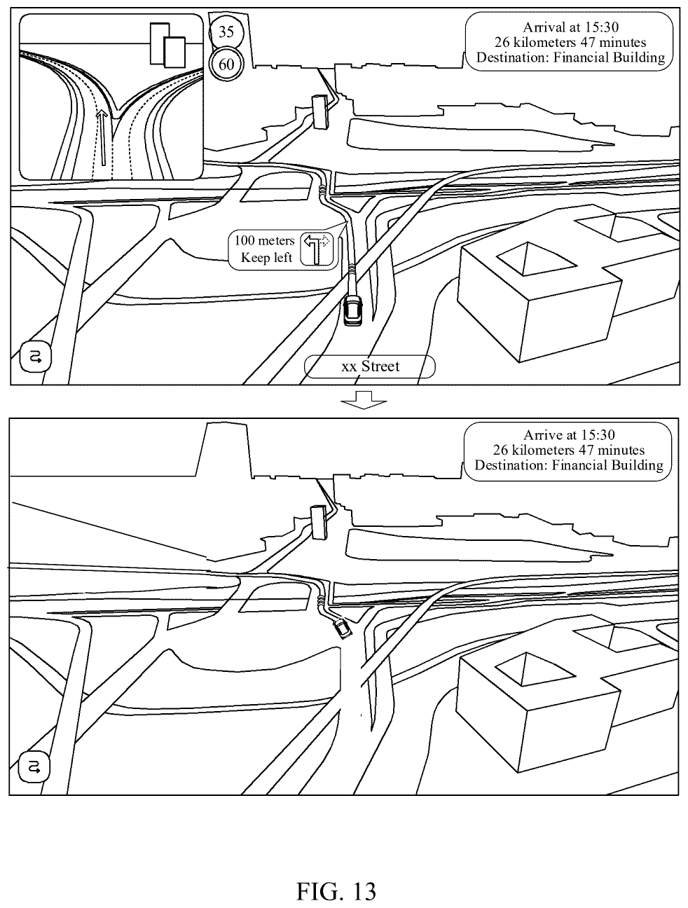

An example in which the i^{th} consecutive turning point group includes the turning point 1, the turning point 2, and the turning point 3 is still used. Referring to FIG. 13, when the target object is 500 meters away from the turning point 1, the terminal device presents the turn guidance area in the navigation interface, and plays the guidance animation corresponding to the i^{th} consecutive turning point group in the turn guidance area. When the target object passes through the turning point 3, the terminal device no longer presents the turn guidance area in the navigation interface.

The following uses a turning point y as an example. The turning point y may be any one of the N turning points, and describes a process of determining whether the target object passes through one turning point.

In one embodiment, the terminal device may determine, based on position data corresponding to the turning point y, that the target object passes through the turning point y when the target object arrives at the turning point y.

For example, still referring to FIG. 4, based on position data respectively corresponding to the turning point A, the turning point B, and the turning point C, the terminal device determines that the target object passes through the turning point A when the target object arrives at the turning point A, determines that the target object passes through the turning point B when the target object arrives at the turning point B, and determines that the target object passes through the turning point C when the target object arrives at the turning point C.

In another embodiment, when it is determined, based on the navigation route, that the target object passes through a pass-through baseline corresponding to the j^{th} turning point in the i^{th} consecutive turning point group, it is determined that the target object passes through the j^{th} turning point, the pass-through baseline being determined based on a position relationship between a first lane to which the j^{th} turning point belongs and a second lane to which the (j+1)^{th} turning point belongs in the navigation route.

A turning point x (the j^{th} turning point) and a turning point y (the (j+1)^{th} turning point) are used as examples. When the terminal device determines, based on the navigation route, that the target object passes through a pass-through baseline corresponding to the turning point y, the terminal device determines that the target object passes through the turning point y. The pass-through baseline is determined based on the position relationship between the first lane to which a previous turning point (assumed to be the turning point x) of the turning point y belongs and the second lane to which the turning point y belongs in the navigation route.

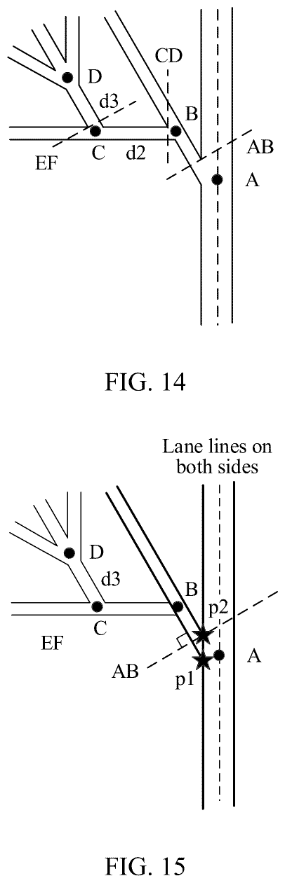

For example, referring to FIG. 14, it is assumed that pass-through baselines respectively corresponding to the turning point A, the turning point B, and the turning point C are respectively a baseline AB, a baseline CD, and a baseline EF. When it is determined, based on the navigation route, that the target object passes through the baseline AB, the terminal device determines that the target object passes through the turning point A. When it is determined, based on the navigation route, that the target object passes through the baseline CD, the terminal device determines that the target object passes through the turning point B. When it is determined, based on the navigation route, that the target object passes through the baseline EF, the terminal device determines that the target object passes through the turning point C.

In a vehicle navigation scenario, when the front of the vehicle passes through the baseline, it may be determined that the target object passes through the baseline. Certainly, it may be determined by using the rear of the vehicle. This is not limited.

For example, the pass-through baseline is determined by the terminal device through the following operations:
determining, by the terminal device based on the navigation route, the first lane to which the turning point x belongs, and the second lane to which the turning point y belongs;
selecting, from position points included in the second lane and based on a position relationship between lane reference lines respectively corresponding to the first lane and the second lane, a reference point that conforms to a preset selection condition; and
obtaining the pass-through baseline based on the selected reference point and in a direction perpendicular to the lane reference line of the second lane.

That the selecting, from position points included in the second lane and based on a position relationship between lane reference lines respectively corresponding to the first lane and the second lane, a reference point that conforms to a preset selection condition includes, but is not limited to, the following cases.

Specifically, the reference lines are lane lines on both sides of lanes. The terminal device obtains intersection points between lane lines on both sides of the first lane and lane lines on both sides of the second lane, and selects, from the obtained intersection points based on the driving direction of the navigation route, an intersection point that conforms to the preset distance condition as a reference point that conforms to the preset selection condition.

The intersection that conforms to the preset distance condition may be an intersection nearest to a current position of the target object, or may be an intersection farthest to the current position. The preset distance condition may be determined according to an actual requirement.

For example, referring to FIG. 15, the terminal device determines, based on the navigation route, the first lane to which the turning point A belongs, and the second lane to which the turning point B belongs. Next, the terminal device obtains an intersection p1 and an intersection p2 between the lane lines on both sides of the first lane and the lane lines on both sides of the second lane; selects, from p1 and p2 based on the driving direction of the navigation route, the intersection p2 that is farthest from the current position as a reference point that conforms to the preset selection condition. Then, the terminal device obtains the pass-through baseline AB based on the selected reference point p2 and in the direction perpendicular to the lane reference line of the second lane.

Based on the pass-through baseline, whether the target object passes through one turning point can be accurately recognized, which can avoid recognition delays caused by positioning information latency, thereby improving the response precision of the navigation guidance.

In some embodiments consistent with the present disclosure, the guidance animation may be determined in, but not limited to, the following manner.

First, the terminal device respectively determines intersection baselines respectively corresponding to the N turning points. Then, the terminal device generates a guidance animation based on the navigation route and the virtual camera perspective.

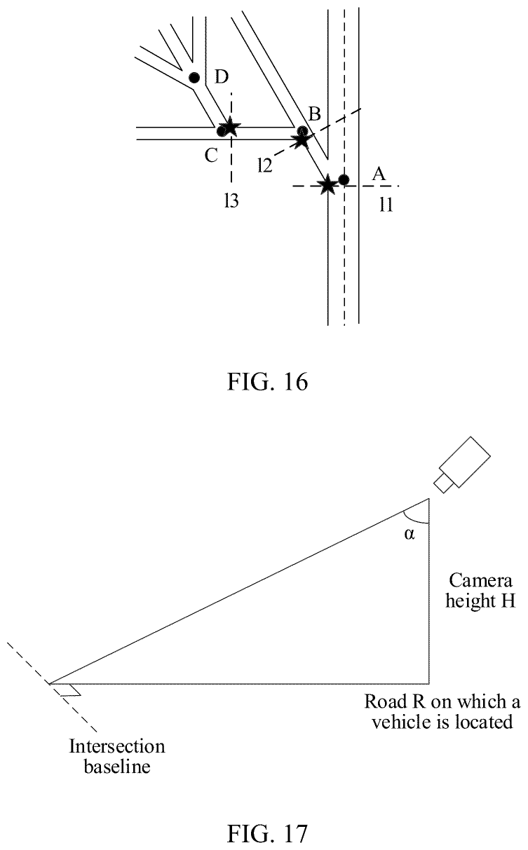

For example, referring to FIG. 16, at intersection positions of three consecutive turning points, points M, N, and P nearest to the current vehicle are taken from intersection points between lane lines on both sides of a next intersection lane and lane lines on both sides of a lane on which the current vehicle is located, and perpendicular lines are drawn from these points to the lane lines on both sides of the lane nearest to the current vehicle, to obtain three intersection baselines: l1, l2, and l3.

Referring to FIG. 17, the virtual camera perspective may also be referred to as a pitch angle, and is denoted by α. A value of α may be 60°. A camera height H may be a fixed value (for example, a default height of zoom level 21). The camera is on the same line as a road R on which the vehicle is located, and is perpendicular to the intersection baselines (for example, l1, l2, and l3). When the vehicle passes through the first turning point (turning point A), in the guidance animation, the camera moves forward at a constant speed along the vehicle's driving path based on the camera height H and the pitch angle α, to a specified position (for example, a visual center) of the second turning point (turning point B), where the forward motion lasts one second. When the vehicle passes through the second turning point (turning point B), in the guidance animation, the camera moves forward at a constant speed along the vehicle's driving path based on the camera height H and the pitch angle α, to a specified position (for example, a visual center) of the third turning point (turning point C), where the forward motion lasts one second. The forward motion duration is not limited to one second, and may also be other values. This is not limited.

In some embodiments consistent with the present disclosure, the guidance animation may be generated by the terminal device, or may be generated by the server and then sent to the terminal device. This is not limited.

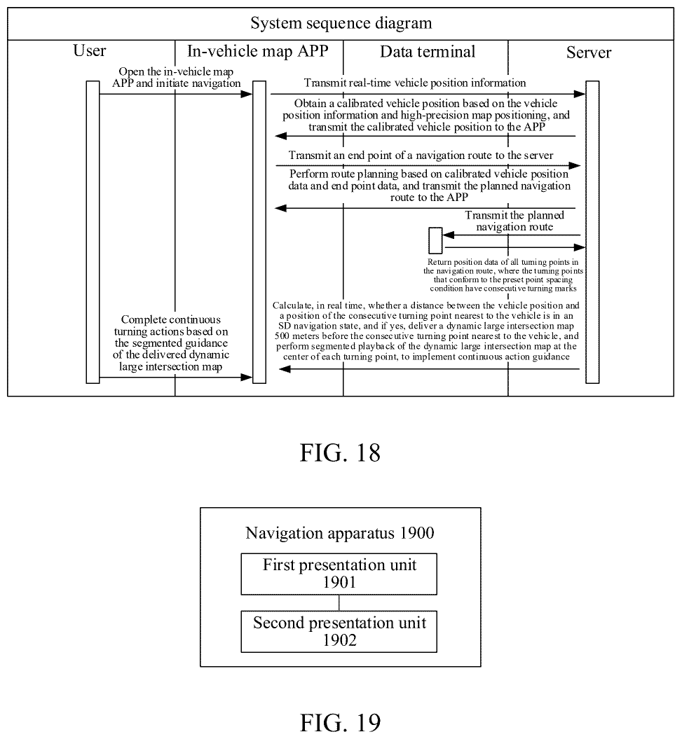

FIG. 18 is a multi-terminal interaction sequence diagram of a navigation method according to an embodiment of this application. A specific implementation process of the method is as follows.

First, when a user opens an in-vehicle map APP and initiates navigation, the APP transmits real-time vehicle position information to a server.

Then, the vehicle transmits image data returned by a sensor such as a camera/radar/lidar to the server in real time, and the server performs real-time vehicle position calibration. The server obtains a calibrated vehicle position based on the vehicle position information and high-precision map positioning, and transmits the calibrated vehicle position to the APP. After the user enters a navigation end point, the APP transmits the end point of a navigation route to the server.

The server performs route planning based on calibrated vehicle position data and end point data, and transmits the planned navigation route to the APP. The APP may present the navigation route in a navigation interface.

The server may further transmit the navigation route to a data terminal. The data terminal obtains position data of all turning points in the navigation route based on the navigation route, and makes marks turning points that conform to a preset point spacing condition (for example, within 200 meters) as consecutive turning points. For example, a turning points 1, 2, 3, 4, . . . , and n in the first consecutive turning point group are marked as 1zx-1, 1zx-2, 1zx-3, 1zx-4, . . . , and 1zx-n; turning points 1, 2, 3, 4, . . . , and n in the second consecutive turning point group are marked as 2zx-1, 2zx-2, 2zx-3, 2zx-4, . . . , and 2zx-n, and so on.

The data terminal returns the position data of all turning points in the navigation route to the server, where the turning points that conform to the preset point spacing condition have consecutive turn marks.

The server calculates, in real time, whether a distance between the vehicle position and a position of the consecutive turning point nearest to the vehicle is in an SD navigation state, and if yes, deliver a dynamic large intersection map 500 meters before the consecutive turning point nearest to the vehicle, and perform segmented playback of the dynamic large intersection map at the center of each turning point, to implement continuous action guidance.

The user completes continuous turning actions based on the segmented guidance of the delivered dynamic large intersection map.

An embodiment of this application provides a navigation apparatus. As shown in FIG. 19, FIG. 19 is a schematic structural diagram of a navigation apparatus 1900. The navigation apparatus 1900 may include:

a first presentation unit 1901, configured to: present, in a navigation interface for a target object, a real-time position of the target object moving along a navigation route, the navigation route including at least one consecutive turning point group, and each consecutive turning point group including at least two turning points that conform to a preset point spacing condition; and

a second presentation unit 1902, configured to: present, when a distance between the target object and an i^{th} consecutive turning point group conforms to a preset distance range, turn indication information for the at least two turning points in the i^{th} consecutive turning point group in the navigation interface, the i^{th} consecutive turning point group being one of the at least one consecutive turning point group.

In one embodiment, the first presentation unit 1901 is specifically configured to:
present, when the distance between the target object and the first turning point in the i^{th} consecutive turning point group is less than a first preset distance threshold, the turn indication information for the at least two turning points in the navigation interface; and
when the target object passes through a j^{th} turning point, present turn indication information for a (j+1)^{th} turning point, and turn indication information for a subsequent turning point after the (j+1)^{th} turning point in the navigation interface, where when the i^{th} consecutive turning point group includes N turning points, 1<j<N.

In one embodiment, when the i^{th} consecutive turning point group includes the N turning points, for a k^{th} turning point of the N turning points, 1≤k≤N, and the first presentation unit 1901 is specifically configured to:
present a prompt box corresponding to the k^{th} turning point, the prompt box including drivable directions corresponding to the k^{th} turning point, the drivable directions including a target driving direction of the target object at the k^{th} turning point, and the target driving direction being highlighted.

In one embodiment, the first presentation unit 1901 is specifically configured to:
present, the prompt box corresponding to the k^{th} turning point in the navigation interface at a preset position associated with the k^{th} turning point.

In one embodiment, the navigation interface includes a turn guidance area, and the second presentation unit 1902 is specifically configured to:
present, when the distance between the target object and the i^{th} consecutive turning point group conforms to the preset distance range, a guidance animation corresponding to the i^{th} consecutive turning point group in the turn guidance area, the guidance animation being configured for guiding the target object to pass through the i^{th} consecutive turning point group.

In one embodiment, a layer of the turn guidance area is located above a layer of the navigation interface.

In one embodiment, the turn guidance area is located at a preset position at the upper left side of the navigation interface.

In one embodiment, the guidance animation corresponding to the i^{th} consecutive turning point group includes guidance sub-animations respectively corresponding to the at least two turning points in one consecutive turning point group, and the second presentation unit 1902 is specifically configured to:
sequentially present, when the distance between the target object and the i^{th} consecutive turning point group conforms to the preset distance range, the guidance sub-animations respectively corresponding to the at least two turning points in the turn guidance area.

In one embodiment, the second presentation unit 1902 is specifically configured to:
play, when the distance between the target object and the first turning point in the i^{th} consecutive turning point group is less than a first specified distance, a guidance sub-animation corresponding to the first turning point in the turn guidance area; and
play, when the target object passes through the j^{th} turning point, a guidance sub-animation corresponding to the (j+1)^{th} turning point in the turn guidance area, where the i^{th} consecutive turning point group includes the N turning points, 1<j<N.

In one embodiment, the second presentation unit 1902 is further configured to:
continuously present, after playing of a guidance sub-animation corresponding to the j^{th} turning point is completed, a static guidance image corresponding to the (j+1)^{th} turning point in the turn guidance area until the target object passes through the j^{th} turning point.

In one embodiment, the second presentation unit 1902 is further configured to:
skip presenting the turn guidance area in the navigation interface when the target object passes through the last turning point in the i^{th} consecutive turning point group.

In one embodiment, when the i^{th} consecutive turning point group includes the N turning points, for a k^{th} turning point of the N turning points, 1≤k≤N, and the second presentation unit 1902 is specifically configured to:
present, with an approach lane and an exit lane corresponding to the k^{th} turning point as a visual center, a turning process of the target object passing through the approach lane and entering the exit lane from a virtual camera perspective in the turn guidance area.

In one embodiment, the second presentation unit 1902 is specifically configured to:
determine, when it is determined, based on the navigation route, that the target object passes through a pass-through baseline corresponding to the j^{th} turning point in the i^{th} consecutive turning point group, that the target object passes through the j^{th} turning point, the pass-through baseline being determined based on a position relationship between a first lane to which the j^{th} turning point belongs and a second lane to which the (j+1)^{th} turning point belongs in the navigation route.

In one embodiment, the second presentation unit 1902 is specifically configured to determine the pass-through baseline in the following manners:
determining, based on the navigation route, the first lane to which the j^{th} turning point belongs, and determine the second lane to which the (j+1)^{th} turning point belongs;
selecting, from position points included in the second lane and based on a position relationship between lane reference lines respectively corresponding to the first lane and the second lane, a reference point that conforms to a preset selection condition; and
obtaining the pass-through baseline based on the selected reference point and in a direction perpendicular to the lane reference line of the second lane.

In one embodiment, the navigation interface includes a turn guidance area, and the second presentation unit 1902 is further configured to:
present, when the distance between the target object and the i^{th} consecutive turning point group conforms to the preset distance range, a static guidance image corresponding to the i^{th} consecutive turning point group in the turn guidance area; or
present, when the distance between the target object and the i^{th} consecutive turning point group conforms to the preset distance range, a guidance text corresponding to the i^{th} consecutive turning point group in the turn guidance area.

In one embodiment, the second presentation unit 1902 is specifically configured to perform at least one of the following operations:
using, if one group of turning points in the turning points in the navigation route that conforms to a preset adjacent point condition, the group of turning points as one consecutive turning point group, the preset adjacent point condition being that distances between two adjacent turning points in the group of turning points are all less than an adjacent point distance threshold; and
using, if one group of turning points in the turning points in the navigation route that conforms to a preset overall condition, the group of turning points as one consecutive turning point group, the preset overall condition being that a sum of the distances between two adjacent turning points in the group of turning points is less than a specified overall distance threshold.

In one embodiment, the second presentation unit 1902 is specifically configured to:
determine, based on a pass-through sequence of the at least two turning points in the i^{th} consecutive turning point group in the navigation route when the distance between the target object and the first turning point in the i^{th} consecutive turning point group is less than a second preset distance threshold, that the distance between the target object and the i^{th} consecutive turning point group conforms to the preset distance range; or
estimate, based on a movement speed of the target object, a reference arrival time when the target object arrives at the first turning point in the i^{th} consecutive turning point group, and determine, based on the reference arrival time when it is determined that the target object is expected to arrive at the first turning point within a specified duration, that the distance between the target object and the i^{th} consecutive turning point group conforms to the preset distance range.

For ease of description, the foregoing parts are divided into modules (or units) based on functions for respective description. Certainly, during implementation of this application, the functions of the modules (or units) may be implemented in one or more pieces of software or hardware.

For the apparatus in the foregoing embodiments, specific manners of executing requests by the units have been described in detail in the embodiments related to the method, and are not described in detail herein.

Persons skilled in the art can understand that various aspects of this application may be implemented as a system, a method, or a program product. Therefore, aspects of this application may be specifically implemented in the following forms: a completely hardware implementation, a completely software implementation (including firmware, microcode, and the like), or an implementation combining hardware and software aspects, which may be collectively referred to as a “circuit”, a “module”, or a “system” herein.

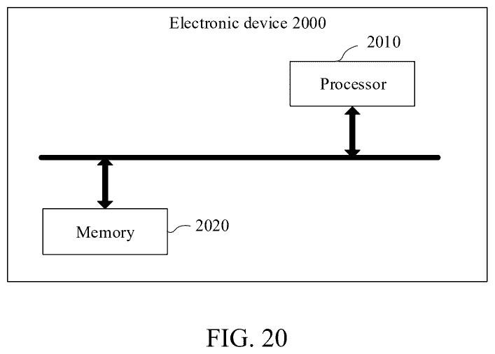

An embodiment of this application further provides an electronic device. In an embodiment, the electronic device may be a server, or may be a terminal device. Referring to FIG. 20, FIG. 20 is a possible schematic structural diagram of an electronic device according to an embodiment of this application. In FIG. 20, the electronic device 2000 includes a processor 2010 and a memory 2020.

The memory 2020 stores a computer program executable by the processor 2010. The processor 2010 may perform the operations of the foregoing navigation method by executing instructions stored in the memory 2020.

The memory 2020 may be a volatile memory, such as a random-access memory (RAM). The memory 2020 may alternatively be a non-volatile memory, for example, a read-only memory (ROM), a flash memory, a hard disk drive (HDD), or a solid-state drive (SSD). Alternatively, the memory 2020 is any other medium that can carry or store desired program code in the form of instructions or a data structure and that can be accessed by a computer. However, this is not limited thereto. The memory 2020 may alternatively be a combination of the foregoing memories.

The processor 2010 may include one or more central processing units (CPUs), is a digital processing unit, or the like. The processor 2010 is configured to implement the foregoing navigation method when executing the computer program stored in the memory 2020.

In some embodiments, the processor 2010 and the memory 2020 may be implemented on the same chip. In some embodiments, the processor 2010 and the memory 2020 may be separately implemented on independent chips.

A specific connection medium between the processor 2010 and the memory 2020 is not limited in some embodiments consistent with the present disclosure. In some embodiments consistent with the present disclosure, an example in which the processor 2010 and the memory 2020 are connected through a bus is used. The bus is described by using a bold line in FIG. 20. A connection manner between other components is merely an example for description, and this is not intended to be a limitation. The bus may be classified into an address bus, a data bus, a control bus, and the like. For ease of description, only one bold line is used for description in FIG. 20, but only one bus or one type of the bus is not described.

Accordingly, an embodiment of this application provides a computer-readable storage medium, including a computer program, when run on an electronic device, the computer program causing the electronic device to perform the operations of the foregoing navigation method.

In some embodiments, the aspects of the navigation method provided in this application may alternatively be implemented in the form of a program product, including a computer program. When the program product is run on the electronic device, the computer program is configured to cause the electronic device to perform the operations in the foregoing navigation method. For example, the electronic device may perform the operations shown in FIG. 2.

The program product may use any combination of one or more readable media. The readable medium may be a readable signal medium or a readable storage medium. The readable storage medium may be, for example, but not limited to, an electrical, magnetic, optical, electromagnetic, infrared, or a semiconductor system, apparatus, or device, or any combination thereof. More specific examples (a non-exhaustive list) of the readable storage medium include an electrical connection having one or more wires, a portable disk, a hard disk, a RAM, a ROM, an erasable programmable read-only memory (EPROM or flash memory), an optical fiber, a portable compact disk read only memory (CD-ROM), an optical storage device, a magnetic storage device, or any suitable combination thereof.

The program product in the embodiments of this application may use the CD-ROM, including the computer program, and may be run on the electronic device. However, the program product of this application is not limited thereto. In this specification, the readable storage medium may be any tangible medium that includes or stores the computer program. The computer program may be used by or in combination with a command execution system, apparatus, or device.

The readable signal medium may include a data signal propagated in a baseband or as a part of a carrier, and carries the readable computer program. The propagated data signal may use various forms, including but not limited to an electromagnetic signal, an optical signal, or any appropriate combination thereof. The readable signal medium may alternatively be any readable medium other than the readable storage medium. The readable medium may send, propagate, or transmit the computer program used by or in combination with a command execution system, apparatus, or device.

Although preferred embodiments of this application have been described, persons skilled in the art can make changes and modifications to these embodiments once they learn the principles of this disclosure. Therefore, the following claims are intended to cover the preferred embodiments and all changes and modifications falling within the scope of this application.

It is clear that persons skilled in the art can make various modifications and variations to this application without departing from the spirit and scope of this application. In this case, if the modifications and variations made to this application fall within the scope of the claims of this application and their equivalent technologies, this application is intended to include these modifications and variations.

What is claimed is:

1. A navigation method, performed by an electronic device, the method comprising:
presenting a real-time position of a target object moving along a navigation route in a navigation interface for the target object, the navigation route comprising at least one consecutive turning point group, and each consecutive turning point group comprising at least two turning points that conform to a preset point spacing condition; and
presenting turn indication information for the at least two turning points in the i^{th} consecutive turning point group in the navigation interface when a distance between the target object and an i^{th} consecutive turning point group conforms to a preset distance range, the i^{th} consecutive turning point group being one of the at least one consecutive turning point group.

2. The method according to claim 1, wherein the presenting turn indication information for the at least two turning points in the i^{th} consecutive turning point group in the navigation interface when a distance between the target object and an i^{th} consecutive turning point group conforms to a preset distance range comprises:
presenting the turn indication information for the at least two turning points in the navigation interface when a distance between the target object and the first turning point in the i^{th} consecutive turning point group is less than a first preset distance threshold; and
when the target object passes through a j^{th} turning point, presenting turn indication information for a (j+1)^{th} turning point, and turn indication information for a subsequent turning point after the (j+1)^{th} turning point in the navigation interface, wherein when the i^{th} consecutive turning point group comprises N turning points, 1<j<N.

3. The method according to claim 1, wherein when the i^{th} consecutive turning point group comprises N turning points, for a k^{th} turning point of the N turning points, 1≤k≤N, and the presenting turn indication information for the at least two turning points in the i^{th} consecutive turning point group in the navigation interface comprises:
presenting a prompt box corresponding to the k^{th} turning point, the prompt box comprising at least one drivable direction corresponding to the k^{th} turning point, the drivable direction comprising a target driving direction of the target object at the k^{th} turning point, and the target driving direction being highlighted.

4. The method according to claim 3, wherein the presenting a prompt box corresponding to the k^{th} turning point comprises:
presenting the prompt box corresponding to the k^{th} turning point in the navigation interface at a preset position associated with the k^{th} turning point.

5. The method according to claim 1, wherein the navigation interface comprises a turn guidance area, and the method further comprises:
presenting a guidance animation corresponding to the i^{th} consecutive turning point group in the turn guidance area when the distance between the target object and the i^{th} consecutive turning point group conforms to the preset distance range, the guidance animation being configured for guiding the target object to pass through the i^{th} consecutive turning point group.

6. The method according to claim 5, wherein a layer of the turn guidance area is located above a layer of the navigation interface.

7. The method according to claim 5, wherein the turn guidance area is located at a preset position at an upper left side of the navigation interface.

8. The method according to claim 5, wherein the guidance animation corresponding to the i^{th} consecutive turning point group comprises guidance sub-animations respectively corresponding to the at least two turning points in the i^{th} consecutive turning point group; and
the presenting a guidance animation corresponding to the i^{th} consecutive turning point group in the turn guidance area when the distance between the target object and the i^{th} consecutive turning point group conforms to the preset distance range, comprises:
sequentially presenting the guidance sub-animations respectively corresponding to the at least two turning points in the turn guidance area when the distance between the target object and the i^{th} consecutive turning point group conforms to the preset distance range.

9. The method according to claim 8, wherein the sequentially presenting the guidance sub-animations respectively corresponding to the at least two turning points in the turn guidance area when the distance between the target object and the i^{th} consecutive turning point group conforms to the preset distance range, comprises:
playing a guidance sub-animation corresponding to the first turning point in the turn guidance area, when the distance between the target object and the first turning point in the i^{th} consecutive turning point group is less than a first specified distance; and
playing a guidance sub-animation corresponding to the (j+1)^{th} turning point in the turn guidance area when the target object passes through the j^{th} turning point, wherein when the i^{th} consecutive turning point group comprises the N turning points, 1<j<N.

10. The method according to claim 9, further comprising:
continuously presenting a static guidance image corresponding to the (j+1)^{th} turning point in the turn guidance area until the target object passes through the j^{th} turning point after playing of a guidance sub-animation corresponding to the j^{th} turning point is completed.

11. The method according to claim 5, further comprising:
skipping presenting the turn guidance area in the navigation interface when the target object passes through the last turning point in the i^{th} consecutive turning point group.

12. The method according to claim 9, wherein when the i^{th} consecutive turning point group comprises the N turning points, for the k^{th} turning point of the N turning points, 1≤k≤N, and the sequentially presenting the guidance sub-animations respectively corresponding to the at least two turning points in the turn guidance area comprises:
presenting a turning process of the target object passing through the approach lane and entering the exit lane with an approach lane and an exit lane corresponding to the k^{th} turning point as a visual center, from a virtual camera perspective in the turn guidance area.

13. The method according to claim 1, further comprising:
determining that the target object passes through the j^{th} turning point when it is determined, based on the navigation route, that the target object passes through a pass-through baseline corresponding to the j^{th} turning point in the i^{th} consecutive turning point group, the pass-through baseline being determined based on a position relationship between a first lane to which the j^{th} turning point belongs and a second lane to which the (j+1)^{th} turning point belongs in the navigation route.

14. The method according to claim 13, wherein the pass-through baseline is determined in the following manners:
determining the first lane to which the j^{th} turning point belongs based on the navigation route, and determining the second lane to which the (j+1)^{th} turning point belongs;
selecting a reference point that conforms to a preset selection condition from position points comprised in the second lane and based on a position relationship between lane reference lines respectively corresponding to the first lane and the second lane; and
obtaining the pass-through baseline based on the selected reference point and in a direction perpendicular to the lane reference line of the second lane.

15. The method according to claim 1, wherein the navigation interface comprises a turn guidance area, and the method further comprises:
presenting a static guidance image corresponding to the i^{th} consecutive turning point group in the turn guidance area when the distance between the target object and the i^{th} consecutive turning point group conforms to the preset distance range; or
presenting a guidance text corresponding to the i^{th} consecutive turning point group in the turn guidance area when the distance between the target object and the i^{th} consecutive turning point group conforms to the preset distance range.

16. The method according to claim 1, wherein determining one consecutive turning point group comprises at least one of the following operations:
using the group of turning points as one consecutive turning point group if one group of turning points in the turning points in the navigation route that conforms to a preset adjacent point condition, the preset adjacent point condition being that distances between two adjacent turning points in the group of turning points are all less than an adjacent point distance threshold; and
using the group of turning points as one consecutive turning point group if one group of turning points in the turning points in the navigation route that conforms to a preset overall condition, the preset overall condition being that a sum of the distances between two adjacent turning points in the group of turning points is less than a specified overall distance threshold.

17. The method according to claim 1, further comprising:
determining, that the distance between the target object and the i^{th} consecutive turning point group conforms to the preset distance range based on a pass-through sequence of the at least two turning points in the i^{th} consecutive turning point group in the navigation route when the distance between the target object and the first turning point in the i^{th} consecutive turning point group is less than a second preset distance threshold; or
estimating a reference arrival time when the target object arrives at the first turning point in the i^{th} consecutive turning point group based on a movement speed of the target object, and determining that the distance between the target object and the i^{th} consecutive turning point group conforms to the preset distance range based on the reference arrival time when it is determined that the target object is expected to arrive at the first turning point within a specified duration.

18. An electronic device, comprising a processor and a memory, the memory having a computer program stored therein, and the computer program, when executed by the processor, causing the processor to perform the operations of a navigation method comprising:
presenting a real-time position of a target object moving along a navigation route in a navigation interface for the target object, the navigation route comprising at least one consecutive turning point group, and each consecutive turning point group comprising at least two turning points that conform to a preset point spacing condition; and
presenting turn indication information for the at least two turning points in the i^{th} consecutive turning point group in the navigation interface when a distance between the target object and an i^{th} consecutive turning point group conforms to a preset distance range, the i^{th} consecutive turning point group being one of the at least one consecutive turning point group.

19. The electronic device according to claim 18, wherein the presenting turn indication information for the at least two turning points in the i^{th} consecutive turning point group in the navigation interface when a distance between the target object and an i^{th} consecutive turning point group conforms to a preset distance range comprises:
presenting the turn indication information for the at least two turning points in the navigation interface when a distance between the target object and the first turning point in the i^{th} consecutive turning point group is less than a first preset distance threshold; and
when the target object passes through a j^{th} turning point, presenting turn indication information for a (j+1)^{th} turning point, and turn indication information for a subsequent turning point after the (j+1)^{th} turning point in the navigation interface, wherein when the i^{th} consecutive turning point group comprises N turning points, 1<j<N.

20. A non-transitory computer-readable storage medium, comprising a computer program, the computer program, when run on an electronic device, being configured to cause the electronic device to perform the operations of a navigation method comprising:
presenting a real-time position of a target object moving along a navigation route in a navigation interface for the target object, the navigation route comprising at least one consecutive turning point group, and each consecutive turning point group comprising at least two turning points that conform to a preset point spacing condition; and
presenting turn indication information for the at least two turning points in the i^{th} consecutive turning point group in the navigation interface when a distance between the target object and an i^{th} consecutive turning point group conforms to a preset distance range, the i^{th} consecutive turning point group being one of the at least one consecutive turning point group.
